(19) United States
(12) Patent Application Publication
(10) Pub. No.: US 2024/0214560 A1
(43) Pub. Date: Jun. 27, 2024

(54) VIDEO ENCODING/DECODING METHOD AND APPARATUS

(71) Applicants: HYUNDAI MOTOR COMPANY, Seoul (KR); KIA CORPORATION, Seoul (KR)

(72) Inventors: Seung Wook Park, Yongin-si (KR); Jin Heo, Yongin-si (KR)

(73) Assignees: HYUNDAI MOTOR COMPANY, Seoul (KR); KIA CORPORATION, Seoul (KR)

(21) Appl. No.: 18/599,947

(22) Filed: Mar. 8, 2024

Related U.S. Application Data
(63) Continuation of application No. PCT/KR2022/013478, filed on Sep. 7, 2022.

(30) Foreign Application Priority Data
Sep. 10, 2021 (KR) 10-2021-0120860
Sep. 1, 2022 (KR) 10-2022-0110561

(51) Int. Cl. H04N 19/11; H04N 19/105; H04N 19/176; H04N 19/88

(52) U.S. Cl. CPC H04N 19/11; H04N 19/105; H04N 19/176; H04N 19/88

(57) ABSTRACT

A method and a device for encoding/decoding a video are provided. The method for decoding a video includes deriving a Most Probable Mode (MPM) list based on intra-prediction modes of at least one neighboring block adjacent to a current block, reordering one or more candidate modes in the MPM list, deriving an intra-prediction mode of the current block based on one or more candidate modes in a reordered MPM list, and generating a prediction block of the current block based on the intra-prediction mode of the current block.

### CROSS-REFERENCE TO RELATED APPLICATION

This application is a continuation of International Application No. PCT/KR2022/013478, filed on Sep. 7, 2022, which claims priority to and the benefit of Korean Patent Application No. 10-2021-0120860, filed on Sep. 10, 2021, and Korean Patent Application No. 10-2022-0110561, filed on Sep. 1, 2022, the entire disclosures of each of which are incorporated herein by reference.

### TECHNICAL FIELD

The present disclosure relates to a video encoding and decoding method and a video encoding and decoding apparatus. More particularly, the present disclosure relates to a video encoding and decoding method and a video encoding and decoding apparatus that derive an optimal intra-prediction mode for the current block based on a template neighboring the current block and a reordered list of Most Probable Modes (MPMs).

### BACKGROUND

The contents described below simply provide background information related to the present embodiment and do not constitute prior art.

Since, the volume of video data is larger than the volume of voice data or still image data, storing or transmitting video data without processing the video data by compression requires a lot of hardware resources including memory.

Accordingly, in storing or transmitting video data, the video data is generally compressed using an encoder so as to be stored or transmitted. Then, a decoder receives the compressed video data and decompresses and reproduces the video data. Compression techniques for such video data include H.264/AVC, high efficiency video coding (HEVC), and versatile video coding (VVC), which improves coding efficiency by about 30% or more compared to HEVC.

However, the video size, resolution, and frame rate are gradually increasing, and thus the amount of data to be encoded is also increasing. Accordingly, a new compression technique having better encoding efficiency and higher image quality than the existing compression technique is required.

Intra prediction is a prediction technique that allows spatial references exclusively and represents a method of predicting the current block that is about to be encoded, by referring to the already reconstructed blocks around the current block. In intra prediction, the intra-prediction mode of the current block may be derived using a Most Probable Mode (MPM) list. The intra-prediction mode of the current block may also be derived by using a template neighboring the current block. When using the template neighboring the current block to derive the intra-prediction mode for the current block, there is a need to improve the encoding efficiency.

### SUMMARY

An object of the present disclosure is to provide a method and an apparatus for deriving an intra-prediction mode of the current block based on a template.

Another object of the present disclosure is to provide a method and an apparatus for deriving an intra-prediction mode of the current block by using an MPM list and a template.

Another object of the present disclosure is to provide a method and an apparatus for ordering candidate modes in a Most Probable Mode (MPM) list by using an intra-prediction mode of a neighboring block of the current block.

Another object of the present disclosure is to provide a method and an apparatus for improving video encoding/decoding efficiency.

Another object of the present disclosure is to provide a recording medium that stores a bitstream generated by a video encoding/decoding method or a video encoding/decoding apparatus of the present disclosure.

Another object of the present disclosure is to provide a method and an apparatus for transmitting a bitstream generated by a video encoding/decoding method or an apparatus of the present disclosure.

According to a present disclosure, a video decoding method includes deriving a Most Probable Mode (MPM) list based on intra-prediction modes of at least one neighboring block adjacent to a current block. The video decoding method also includes reordering one or more candidate modes in the MPM list. The video decoding method also includes deriving an intra-prediction mode of the current block based on one or more candidate modes in a reordered MPM list. The video decoding method also includes generating a prediction block of the current block based on the intra-prediction mode of the current block.

According to the present disclosure, a video encoding method includes determining an MPM list of based on intra-prediction modes of at least one neighboring block adjacent to a current block. The video encoding method also includes reordering one or more candidate modes in the MPM list, determining an intra-prediction mode of the current block based on one or more candidate modes in a reordered MPM list. The video encoding method also includes generating a prediction block of the current block based on the intra-prediction mode of the current block.

In addition, according to the present disclosure, it is possible to provide a method of transmitting a bitstream generated by the video encoding method or apparatus according to the present disclosure.

In addition, according to the present disclosure, it is possible to provide a recording medium storing a bitstream generated by the video encoding method or apparatus according to the present disclosure.

In addition, according to the present disclosure, it is possible to provide a recording medium storing a bitstream received and decoded by the video decoding apparatus according to the present disclosure and used to reconstruct a video.

According to the present disclosure, the method and apparatus may derive an intra-prediction mode of the current block based on a template.

In addition, according to the present disclosure, the method and apparatus may derive an intra-prediction mode of the current block by using an MPM list and a template.

In addition, according to the present disclosure, the method and apparatus may order candidate modes in an MPM list by using an intra-prediction mode of a neighboring block of the current block.

In addition, according to the present disclosure, the method and apparatus for improving video encoding/decoding efficiency may be provided.

The effects that may be obtained from the present disclosure are not limited to the effects mentioned above. Other effects not mentioned may be more clearly understood by those having ordinary skill in the art from the description below.

### BRIEF DESCRIPTION OF THE DRAWINGS

FIG. 1 is a block diagram of a video encoding apparatus that may implement a technology of the present disclosure.

FIG. 2 illustrates a method for partitioning a block using a quadtree plus binarytree ternarytree (QTBTTT) structure.

FIGS. 3A and 3B illustrate a plurality of intra prediction modes including wide-angle intra prediction modes.

FIG. 4 illustrates neighboring blocks of a current block.

FIG. 5 is a block diagram of a video decoding apparatus that may implement technologies of the present disclosure.

FIG. 6 is a diagram illustrating a template used to derive a template-based intra-prediction mode and illustrating a reference pixel of the template, according to at least one embodiment of the present disclosure.

FIG. 7 is a diagram illustrating a syntax associated with an intra-prediction mode of the current block, according to at least one embodiment of the present disclosure.

FIG. 8 is a diagram illustrating a syntax associated with an intra-prediction mode of the current block, according to another embodiment of the present disclosure.

FIG. 9 is a diagram illustrating the current block's neighboring reference blocks used to generate a Most Probable Mode (MPM) list, according to at least one embodiment of the present disclosure.

FIG. 10 is a diagram illustrating a generated MPM list when the intra-prediction modes of two neighboring reference blocks of the current block are different directional modes, according to at least one embodiment of the present disclosure.

FIGS. 11A and 11B are diagrams illustrating a method of reordering an MPM list when the intra-prediction modes of two neighboring reference blocks of the current block are different directional modes, according to at least one embodiment of the present disclosure.

FIGS. 12A and 12B are diagrams illustrating a method of reordering an MPM list when the intra-prediction modes of two neighboring reference blocks of the current block are different directional modes, according to another embodiment of the present disclosure.

FIG. 13A and FIG. 13B are diagrams illustrating a method of reordering an MPM list when the intra-prediction modes of two neighboring reference blocks of the current block are different directional modes, according to yet another embodiment of the present disclosure.

FIG. 14 is a diagram illustrating a generated MPM list when the intra-prediction modes of two neighboring reference blocks of the current block are the same directional mode, or when they are directional and non-directional modes, respectively, according to at least one embodiment of the present disclosure.

FIGS. 15A and 15B are diagrams illustrating a method of reordering an MPM list, according to at least one embodiment of the present disclosure, when the intra-prediction modes of two neighboring reference blocks of the current block are the same directional mode, or when they are a directional mode and a non-directional mode, respectively.

FIG. 16 is a diagram illustrating a method of reordering an MPM list, according to another embodiment of the present disclosure, when the intra-prediction modes of two neighboring reference blocks of the current block are the same directional mode, or when they are a directional mode and a non-directional mode, respectively.

FIG. 17 is a diagram illustrating a generated MPM list when the intra-prediction modes of two neighboring reference blocks of the current block are both non-directional modes, according to at least one embodiment of the present disclosure.

FIGS. 18A and 18B are diagrams illustrating a method of reordering an MPM list when the intra-prediction modes of two neighboring reference blocks of the current block are both non-directional modes, according to at least one embodiment of the present disclosure.

FIG. 19 is a diagram illustrating neighboring blocks of the current block, according to at least one embodiment of the present disclosure.

FIG. 20 is a diagram illustrating a method of generating an MPM list with the sum of absolute transformed differences for intra-prediction modes of neighboring blocks of the current block, according to at least one embodiment of the present disclosure.

FIG. 21 is a diagram illustrating a video decoding process according to at least one embodiment of the present disclosure.

FIG. 22 is a diagram illustrating a video encoding process according to at least one embodiment of the present disclosure.

### DETAILED DESCRIPTION

Hereinafter, some embodiments of the present disclosure are described in detail with reference to the accompanying illustrative drawings. In the following description, like reference numerals designate like elements, although the elements are shown in different drawings. Further, in the following description of some embodiments, detailed descriptions of related known components and functions when considered to obscure the subject of the present disclosure have been omitted for the purpose of clarity and for brevity.

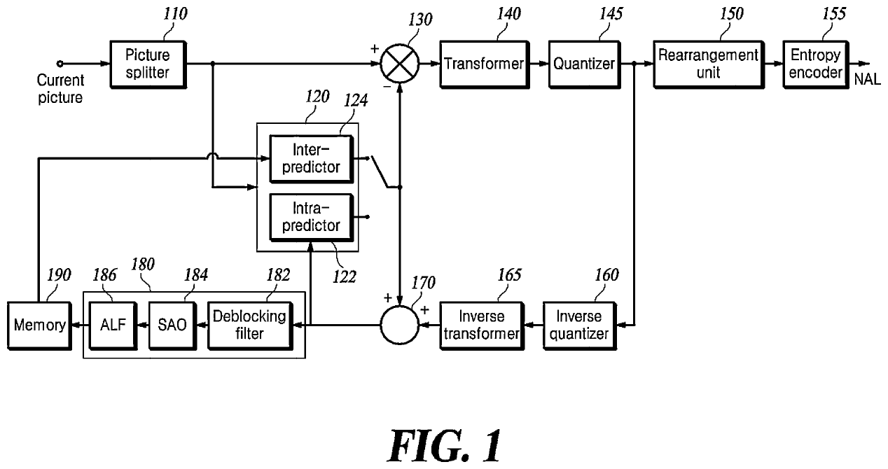

FIG. 1 is a block diagram of a video encoding apparatus that may implement technologies of the present disclosure. Hereinafter, referring to illustration of FIG. 1, the video encoding apparatus and components of the apparatus are described.

The encoding apparatus may include a picture splitter 110, a predictor 120, a subtractor 130, a transformer 140, a quantizer 145, a rearrangement unit 150, an entropy encoder 155, an inverse quantizer 160, an inverse transformer 165, an adder 170, a loop filter unit 180, and a memory 190.

Each component of the encoding apparatus may be implemented as hardware or software or implemented as a combination of hardware and software. Further, a function of each component may be implemented as software, and a microprocessor may also be implemented to execute the function of the software corresponding to each component.

One video is constituted by one or more sequences including a plurality of pictures. Each picture is split into a plurality of areas, and encoding is performed for each area. For example, one picture is split into one or more tiles or/and slices. Here, one or more tiles may be defined as a tile group. Each tile or/and slice is split into one or more coding tree units (CTUs). In addition, each CTU is split into one or more coding units (CUs) by a tree structure. Information applied to each coding unit (CU) is encoded as a syntax of the CU and information commonly applied to the CUs included in one CTU is encoded as the syntax of the CTU. Further, information commonly applied to all blocks in one slice is encoded as the syntax of a slice header, and information applied to all blocks constituting one or more pictures is encoded to a picture parameter set (PPS) or a picture header. Furthermore, information, which the plurality of pictures commonly refers to, is encoded to a sequence parameter set (SPS). In addition, information, which one or more SPS commonly refer to, is encoded to a video parameter set (VPS). Further, information commonly applied to one tile or tile group may also be encoded as the syntax of a tile or tile group header. The syntaxes included in the SPS, the PPS, the slice header, the tile, or the tile group header may be referred to as a high level syntax.

The picture splitter 110 determines a size of a coding tree unit (CTU). Information on the size of the CTU (CTU size) is encoded as the syntax of the SPS or the PPS and delivered to a video decoding apparatus.

The picture splitter 110 splits each picture constituting the video into a plurality of coding tree units (CTUs) having a predetermined size and then recursively splits the CTU by using a tree structure. A leaf node in the tree structure becomes the coding unit (CU), which is a basic unit of encoding.

The tree structure may be a quadtree (QT) in which a higher node (or a parent node) is split into four lower nodes (or child nodes) having the same size. The tree structure may also be a binarytree (BT) in which the higher node is split into two lower nodes. The tree structure may also be a ternarytree (TT) in which the higher node is split into three lower nodes at a ratio of 1:2:1. The tree structure may also be a structure in which two or more structures among the QT structure, the BT structure, and the TT structure are mixed. For example, a quadtree plus binarytree (QTBT) structure may be used or a quadtree plus binarytree ternarytree (QTBTTT) structure may be used. Here, a BTTT is added to the tree structures to be referred to as a multiple-type tree (MTT).

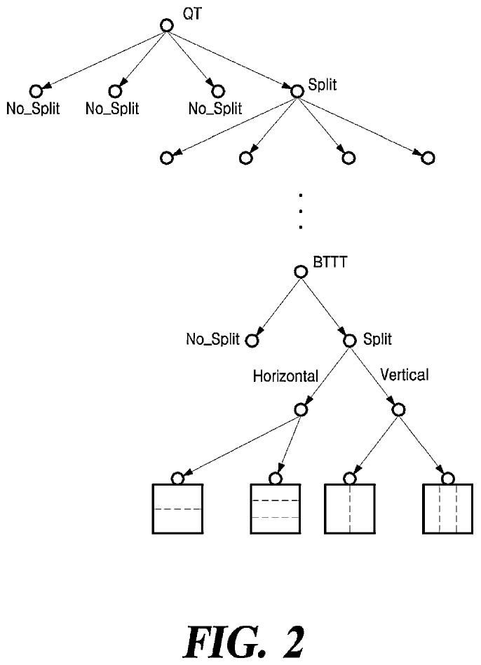

FIG. 2 is a diagram for describing a method for splitting a block by using a QTBTTT structure.

As illustrated in FIG. 2, the CTU may first be split into the QT structure. Quadtree splitting may be recursive until the size of a splitting block reaches a minimum block size (MinQTSize) of the leaf node permitted in the QT. A first flag (QT_split_flag) indicating whether each node of the QT structure is split into four nodes of a lower layer is encoded by the entropy encoder 155 and signaled to the video decoding apparatus. When the leaf node of the QT is not larger than a maximum block size (MaxBTSize) of a root node permitted in the BT, the leaf node may be further split into at least one of the BT structure or the TT structure. A plurality of split directions may be present in the BT structure and/or the TT structure. For example, there may be two directions, i.e., a direction in which the block of the corresponding node is split horizontally and a direction in which the block of the corresponding node is split vertically. As illustrated in FIG. 2, when the MTT splitting starts, a second flag (mtt_split_flag) indicating whether the nodes are split, and a flag additionally indicating the split direction (vertical or horizontal), and/or a flag indicating a split type (binary or ternary) if the nodes are split are encoded by the entropy encoder 155 and signaled to the video decoding apparatus.

Alternatively, prior to encoding the first flag (QT_split_flag) indicating whether each node is split into four nodes of the lower layer, a CU split flag (split_cu_flag) indicating whether the node is split may also be encoded. When a value of the CU split flag (split_cu_flag) indicates that each node is not split, the block of the corresponding node becomes the leaf node in the split tree structure and becomes the CU, which is the basic unit of encoding. When the value of the CU split flag (split_cu_flag) indicates that each node is split, the video encoding apparatus starts encoding the first flag first by the above-described scheme.

When the QTBT is used as another example of the tree structure, there may be two types, i.e., a type (i.e., symmetric horizontal splitting) in which the block of the corresponding node is horizontally split into two blocks having the same size and a type (i.e., symmetric vertical splitting) in which the block of the corresponding node is vertically split into two blocks having the same size. A split flag (split_flag) indicating whether each node of the BT structure is split into the block of the lower layer and split type information indicating a splitting type are encoded by the entropy encoder 155 and delivered to the video decoding apparatus. Meanwhile, a type in which the block of the corresponding node is split into two blocks of a form of being asymmetrical to each other may be additionally present. The asymmetrical form may include a form in which the block of the corresponding node is split into two rectangular blocks having a size ratio of 1:3 or may also include a form in which the block of the corresponding node is split in a diagonal direction.

The CU may have various sizes according to QTBT or QTBTTT splitting from the CTU. Hereinafter, a block corresponding to a CU (i.e., the leaf node of the QTBTTT) to be encoded or decoded is referred to as a “current block”. As the QTBTTT splitting is adopted, a shape of the current block may also be a rectangular shape in addition to a square shape.

The predictor 120 predicts the current block to generate a prediction block. The predictor 120 includes an intra predictor 122 and an inter predictor 124.

In general, each of the current blocks in the picture may be predictively coded. In general, the prediction of the current block may be performed by using an intra prediction technology (using data from the picture including the current block) or an inter prediction technology (using data from a picture coded before the picture including the current block). The inter prediction includes both unidirectional prediction and bidirectional prediction.

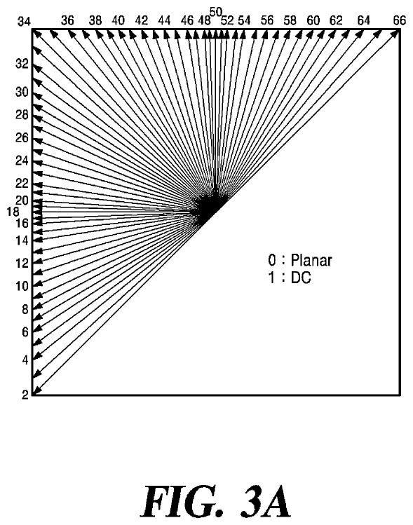

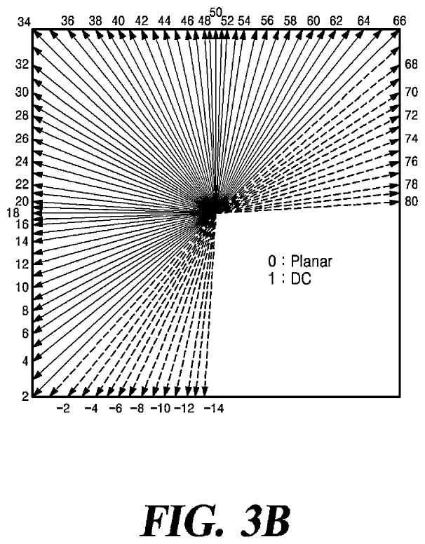

The intra predictor 122 predicts pixels in the current block by using pixels (reference pixels) positioned on a neighbor of the current block in the current picture including the current block. There is a plurality of intra prediction modes according to the prediction direction. For example, as illustrated in FIG. 3A, the plurality of intra prediction modes may include 2 non-directional modes including a Planar mode and a DC mode and may include 65 directional modes. A neighboring pixel and an arithmetic equation to be used are defined differently according to each prediction mode.

For efficient directional prediction for the current block having a rectangular shape, directional modes (#67 to #80, intra prediction modes #−1 to #−14) illustrated as dotted arrows in FIG. 3B may be additionally used. The directional modes may be referred to as “wide angle intra-prediction modes”. In FIG. 3B, the arrows indicate corresponding reference samples used for the prediction and do not represent the prediction directions. The prediction direction is opposite to a direction indicated by the arrow. When the current block has the rectangular shape, the wide angle intra-prediction modes are modes in which the prediction is performed in an opposite direction to a specific directional mode without additional bit transmission. In this case, among the wide angle intra-prediction modes, some wide angle intra-prediction modes usable for the current block may be determined by a ratio of a width and a height of the current block having the rectangular shape. For example, when the current block has a rectangular shape in which the height is smaller than the width, wide angle intra-prediction modes (intra prediction modes #67 to #80) having an angle smaller than 45 degrees are usable. When the current block has a rectangular shape in which the width is larger than the height, the wide angle intra-prediction modes having an angle larger than −135 degrees are usable.

The intra predictor 122 may determine an intra prediction to be used for encoding the current block. In some examples, the intra predictor 122 may encode the current block by using multiple intra prediction modes and may also select an appropriate intra prediction mode to be used from tested modes. For example, the intra predictor 122 may calculate rate-distortion values by using a rate-distortion analysis for multiple tested intra prediction modes and may also select an intra prediction mode having best rate-distortion features among the tested modes.

The intra predictor 122 selects one intra prediction mode among a plurality of intra prediction modes and predicts the current block by using a neighboring pixel (reference pixel) and an arithmetic equation determined according to the selected intra prediction mode. Information on the selected intra prediction mode is encoded by the entropy encoder 155 and delivered to the video decoding apparatus.

The inter predictor 124 generates the prediction block for the current block by using a motion compensation process. The inter predictor 124 searches a block most similar to the current block in a reference picture encoded and decoded earlier than the current picture and generates the prediction block for the current block by using the searched block. In addition, a motion vector (MV) is generated, which corresponds to a displacement between the current bock in the current picture and the prediction block in the reference picture. In general, motion estimation is performed for a luma component, and a motion vector calculated based on the luma component is used for both the luma component and a chroma component. Motion information including information on the reference picture and information on the motion vector used for predicting the current block is encoded by the entropy encoder 155 and delivered to the video decoding apparatus.

The inter predictor 124 may also perform interpolation for the reference picture or a reference block in order to increase accuracy of the prediction. In other words, sub-samples between two contiguous integer samples are interpolated by applying filter coefficients to a plurality of contiguous integer samples including two integer samples. When a process of searching a block most similar to the current block is performed for the interpolated reference picture, not integer sample unit precision but decimal unit precision may be expressed for the motion vector. Precision or resolution of the motion vector may be set differently for each target area to be encoded, e.g., a unit such as the slice, the tile, the CTU, the CU, etc. When such an adaptive motion vector resolution (AMVR) is applied, information on the motion vector resolution to be applied to each target area should be signaled for each target area. For example, when the target area is the CU, the information on the motion vector resolution applied for each CU is signaled. The information on the motion vector resolution may be information representing precision of a motion vector difference to be described below.

Meanwhile, the inter predictor 124 may perform inter prediction by using bi-prediction. In the case of bi-prediction, two reference pictures and two motion vectors representing a block position most similar to the current block in each reference picture are used. The inter predictor 124 selects a first reference picture and a second reference picture from reference picture list 0 (RefPicList0) and reference picture list 1 (RefPicList1), respectively. The inter predictor 124 also searches blocks most similar to the current blocks in the respective reference pictures to generate a first reference block and a second reference block. In addition, the prediction block for the current block is generated by averaging or weighted-averaging the first reference block and the second reference block. In addition, motion information including information on two reference pictures used for predicting the current block and information on two motion vectors is delivered to the entropy encoder 155. Here, reference picture list 0 may be constituted by pictures before the current picture in a display order among pre-reconstructed pictures, and reference picture list 1 may be constituted by pictures after the current picture in the display order among the pre-reconstructed pictures. However, although not particularly limited thereto, the pre-reconstructed pictures after the current picture in the display order may be additionally included in reference picture list 0. Inversely, the pre-reconstructed pictures before the current picture may also be additionally included in reference picture list 1.

In order to minimize a bit quantity consumed for encoding the motion information, various methods may be used.

For example, when the reference picture and the motion vector of the current block are the same as the reference picture and the motion vector of the neighboring block, information capable of identifying the neighboring block is encoded to deliver the motion information of the current block to the video decoding apparatus. Such a method is referred to as a merge mode.

In the merge mode, the inter predictor 124 selects a predetermined number of merge candidate blocks (hereinafter, referred to as a “merge candidate”) from the neighboring blocks of the current block.

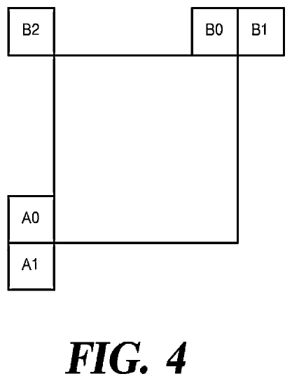

As a neighboring block for deriving the merge candidate, all or some of a left block A0, a bottom left block A1, a top block B0, a top right block B1, and a top left block B2 adjacent to the current block in the current picture may be used as illustrated in FIG. 4. Further, a block positioned within the reference picture (may be the same as or different from the reference picture used for predicting the current block) other than the current picture at which the current block is positioned may also be used as the merge candidate. For example, a co-located block with the current block within the reference picture or blocks adjacent to the co-located block may be additionally used as the merge candidate. If the number of merge candidates selected by the method described above is smaller than a preset number, a zero vector is added to the merge candidate.

The inter predictor 124 configures a merge list including a predetermined number of merge candidates by using the neighboring blocks. A merge candidate to be used as the motion information of the current block is selected from the merge candidates included in the merge list, and merge index information for identifying the selected candidate is generated. The generated merge index information is encoded by the entropy encoder 155 and delivered to the video decoding apparatus.

A merge skip mode is a special case of the merge mode. After quantization, when all transform coefficients for entropy encoding are close to zero, only the neighboring block selection information is transmitted without transmitting residual signals. By using the merge skip mode, it is possible to achieve a relatively high encoding efficiency for images with slight motion, still images, screen content images, and the like.

Hereafter, the merge mode and the merge skip mode are collectively referred to as the merge/skip mode.

Another method for encoding the motion information is an advanced motion vector prediction (AMVP) mode.

In the AMVP mode, the inter predictor 124 derives motion vector predictor candidates for the motion vector of the current block by using the neighboring blocks of the current block. As a neighboring block used for deriving the motion vector predictor candidates, all or some of a left block A0, a bottom left block A1, a top block B0, a top right block B1, and a top left block B2 adjacent to the current block in the current picture illustrated in FIG. 4 may be used. Further, a block positioned within the reference picture (may be the same as or different from the reference picture used for predicting the current block) other than the current picture at which the current block is positioned may also be used as the neighboring block used for deriving the motion vector predictor candidates. For example, a co-located block with the current block within the reference picture or blocks adjacent to the co-located block may be used. If the number of motion vector candidates selected by the method described above is smaller than a preset number, a zero vector is added to the motion vector candidate.

The inter predictor 124 derives the motion vector predictor candidates by using the motion vector of the neighboring blocks and determines motion vector predictor for the motion vector of the current block by using the motion vector predictor candidates. In addition, a motion vector difference is calculated by subtracting motion vector predictor from the motion vector of the current block.

The motion vector predictor may be obtained by applying a pre-defined function (e.g., center value and average value computation, etc.) to the motion vector predictor candidates. In this case, the video decoding apparatus also knows the pre-defined function. Further, because the neighboring block used for deriving the motion vector predictor candidate is a block in which encoding and decoding are already completed, the video decoding apparatus may also already know the motion vector of the neighboring block. Therefore, the video encoding apparatus does not need to encode information for identifying the motion vector predictor candidate. Accordingly, in this case, information on the motion vector difference and information on the reference picture used for predicting the current block are encoded.

Meanwhile, the motion vector predictor may also be determined by a scheme of selecting any one of the motion vector predictor candidates. In this case, information for identifying the selected motion vector predictor candidate is additional encoded jointly with the information on the motion vector difference and the information on the reference picture used for predicting the current block.

The subtractor 130 generates a residual block by subtracting the prediction block generated by the intra predictor 122 or the inter predictor 124 from the current block.

The transformer 140 transforms residual signals in a residual block having pixel values of a spatial domain into transform coefficients of a frequency domain. The transformer 140 may transform residual signals in the residual block by using a total size of the residual block as a transform unit or may also split the residual block into a plurality of subblocks and may perform the transform by using the subblock as the transform unit. Alternatively, the residual block is divided into two subblocks, which are a transform area and a non-transform area, to transform the residual signals by using only the transform area subblock as the transform unit. Here, the transform area subblock may be one of two rectangular blocks having a size ratio of 1:1 based on a horizontal axis (or vertical axis). In this case, a flag (cu_sbt_flag) indicates that only the subblock is transformed, and directional (vertical/horizontal) information (cu_sbt_horizontal_flag) and/or positional information (cu_sbt_pos_flag) are encoded by the entropy encoder 155 and signaled to the video decoding apparatus. Further, a size of the transform area subblock may have a size ratio of 1:3 based on the horizontal axis (or vertical axis). In this case, a flag (cu_sbt_quad_flag) dividing the corresponding splitting is additionally encoded by the entropy encoder 155 and signaled to the video decoding apparatus.

Meanwhile, the transformer 140 may perform the transform for the residual block individually in a horizontal direction and a vertical direction. For the transform, various types of transform functions or transform matrices may be used. For example, a pair of transform functions for horizontal transform and vertical transform may be defined as a multiple transform set (MTS). The transformer 140 may select one transform function pair having highest transform efficiency in the MTS and may transform the residual block in each of the horizontal and vertical directions. Information (mts_idx) on the transform function pair in the MTS is encoded by the entropy encoder 155 and signaled to the video decoding apparatus.

The quantizer 145 quantizes the transform coefficients output from the transformer 140 using a quantization parameter and outputs the quantized transform coefficients to the entropy encoder 155. The quantizer 145 may also immediately quantize the related residual block without the transform for any block or frame. The quantizer 145 may also apply different quantization coefficients (scaling values) according to positions of the transform coefficients in the transform block. A quantization matrix applied to quantized transform coefficients arranged in 2 dimensional may be encoded and signaled to the video decoding apparatus.

The rearrangement unit 150 may perform realignment of coefficient values for quantized residual values.

The rearrangement unit 150 may change a 2D coefficient array to a 1D coefficient sequence by using coefficient scanning. For example, the rearrangement unit 150 may output the 1D coefficient sequence by scanning a

DC coefficient to a high-frequency domain coefficient by using a zig-zag scan or a diagonal scan. According to the size of the transform unit and the intra prediction mode, vertical scan of scanning a 2D coefficient array in a column direction and horizontal scan of scanning a 2D block type coefficient in a row direction may also be used instead of the zig-zag scan. In other words, according to the size of the transform unit and the intra prediction mode, a scan method to be used may be determined among the zig-zag scan, the diagonal scan, the vertical scan, and the horizontal scan.

The entropy encoder 155 generates a bitstream by encoding a sequence of 1D quantized transform coefficients output from the rearrangement unit 150 by using various encoding schemes including a Context-based Adaptive Binary Arithmetic Code (CABAC), an Exponential Golomb, or the like.

Further, the entropy encoder 155 encodes information such as a CTU size, a CTU split flag, a QT split flag, an MTT split type, an MTT split direction, etc., related to the block splitting to allow the video decoding apparatus to split the block equally to the video encoding apparatus. Further, the entropy encoder 155 encodes information on a prediction type indicating whether the current block is encoded by intra prediction or inter prediction. The entropy encoder 155 encodes intra prediction information (i.e., information on an intra prediction mode) or inter prediction information (in the case of the merge mode, a merge index and in the case of the AMVP mode, information on the reference picture index and the motion vector difference) according to the prediction type. Further, the entropy encoder 155 encodes information related to quantization, i.e., information on the quantization parameter and information on the quantization matrix.

The inverse quantizer 160 dequantizes the quantized transform coefficients output from the quantizer 145 to generate the transform coefficients. The inverse transformer 165 transforms the transform coefficients output from the inverse quantizer 160 into a spatial domain from a frequency domain to reconstruct the residual block.

The adder 170 adds the reconstructed residual block and the prediction block generated by the predictor 120 to reconstruct the current block. Pixels in the reconstructed current block may be used as reference pixels when intra-predicting a next-order block.

The loop filter unit 180 performs filtering for the reconstructed pixels in order to reduce blocking artifacts, ringing artifacts, blurring artifacts, etc., which occur due to block based prediction and transform/quantization. The loop filter unit 180 as an in-loop filter may include all or some of a deblocking filter 182, a sample adaptive offset (SAO) filter 184, and an adaptive loop filter (ALF) 186.

The deblocking filter 182 filters a boundary between the reconstructed blocks in order to remove a blocking artifact, which occurs due to block unit encoding/decoding, and the SAO filter 184 and the ALF 186 perform additional filtering for a deblocked filtered video. The SAO filter 184 and the ALF 186 are filters used for compensating differences between the reconstructed pixels and original pixels, which occur due to lossy coding. The SAO filter 184 applies an offset as a CTU unit to enhance a subjective image quality and encoding efficiency. On the other hand, the ALF 186 performs block unit filtering and compensates distortion by applying different filters by dividing a boundary of the corresponding block and a degree of a change amount. Information on filter coefficients to be used for the ALF may be encoded and signaled to the video decoding apparatus.

The reconstructed block filtered through the deblocking filter 182, the SAO filter 184, and the ALF 186 is stored in the memory 190. When all blocks in one picture are reconstructed, the reconstructed picture may be used as a reference picture for inter predicting a block within a picture to be encoded afterwards.

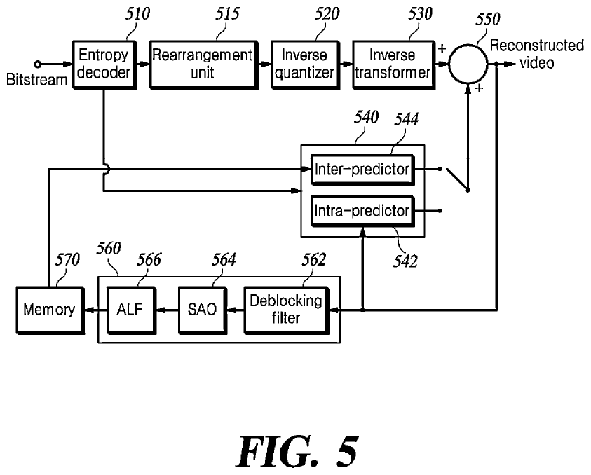

FIG. 5 is a functional block diagram of a video decoding apparatus that may implement the technologies of the present disclosure. Hereinafter, referring to FIG. 5, the video decoding apparatus and components of the apparatus are described.

The video decoding apparatus may include an entropy decoder 510, a rearrangement unit 515, an inverse quantizer 520, an inverse transformer 530, a predictor 540, an adder 550, a loop filter unit 560, and a memory 570.

Similar to the video encoding apparatus of FIG. 1, each component of the video decoding apparatus may be implemented as hardware or software or implemented as a combination of hardware and software. Further, a function of each component may be implemented as the software, and a microprocessor may also be implemented to execute the function of the software corresponding to each component.

The entropy decoder 510 extracts information related to block splitting by decoding the bitstream generated by the video encoding apparatus to determine a current block to be decoded and extracts prediction information required for restoring the current block and information on the residual signals.

The entropy decoder 510 determines the size of the CTU by extracting information on the CTU size from a sequence parameter set (SPS) or a picture parameter set (PPS) and splits the picture into CTUs having the determined size. In addition, the CTU is determined as a highest layer of the tree structure, i.e., a root node, and split information for the CTU may be extracted to split the CTU by using the tree structure.

For example, when the CTU is split by using the QTBTTT structure, a first flag (QT_split_flag) related to splitting of the QT is first extracted to split each node into four nodes of the lower layer. In addition, a second flag (mtt_split_flag), a split direction (vertical/horizontal), and/or a split type (binary/ternary) related to splitting of the MTT are extracted with respect to the node corresponding to the leaf node of the QT to split the corresponding leaf node into an MTT structure. As a result, each of the nodes below the leaf node of the QT is recursively split into the BT or TT structure.

As another example, when the CTU is split by using the QTBTTT structure, a CU split flag (split_cu_flag) indicating whether the CU is split is extracted. When the corresponding block is split, the first flag (QT_split_flag) may also be extracted. During a splitting process, with respect to each node, recursive MTT splitting of 0 times or more may occur after recursive QT splitting of 0 times or more. For example, with respect to the CTU, the MTT splitting may immediately occur or on the contrary, only QT splitting of multiple times may also occur.

As another example, when the CTU is split by using the QTBT structure, the first flag (QT_split_flag) related to the splitting of the QT is extracted to split each node into four nodes of the lower layer. In addition, a split flag (split_flag) indicating whether the node corresponding to the leaf node of the QT being further split into the BT, and split direction information are extracted.

Meanwhile, when the entropy decoder 510 determines a current block to be decoded by using the splitting of the tree structure, the entropy decoder 510 extracts information on a prediction type indicating whether the current block is intra predicted or inter predicted. When the prediction type information indicates the intra prediction, the entropy decoder 510 extracts a syntax element for intra prediction information (intra prediction mode) of the current block. When the prediction type information indicates the inter prediction, the entropy decoder 510 extracts information representing a syntax element for inter prediction information, i.e., a motion vector and a reference picture to which the motion vector refers.

Further, the entropy decoder 510 extracts quantization related information and extracts information on the quantized transform coefficients of the current block as the information on the residual signals.

The rearrangement unit 515 may change a sequence of 1D quantized transform coefficients entropy-decoded by the entropy decoder 510 to a 2D coefficient array (i.e., block) again in a reverse order to the coefficient scanning order performed by the video encoding apparatus.

The inverse quantizer 520 dequantizes the quantized transform coefficients and dequantizes the quantized transform coefficients by using the quantization parameter. The inverse quantizer 520 may also apply different quantization coefficients (scaling values) to the quantized transform coefficients arranged in 2D. The inverse quantizer 520 may perform dequantization by applying a matrix of the quantization coefficients (scaling values) from the video encoding apparatus to a 2D array of the quantized transform coefficients.

The inverse transformer 530 generates the residual block for the current block by restoring the residual signals by inversely transforming the dequantized transform coefficients into the spatial domain from the frequency domain.

Further, when the inverse transformer 530 inversely transforms a partial area (subblock) of the transform block, the inverse transformer 530 extracts a flag (cu_sbt_flag) that only the subblock of the transform block is transformed, directional (vertical/horizontal) information (cu_sbt_horizontal_flag) of the subblock, and/or positional information (cu_sbt_pos_flag) of the subblock. The inverse transformer 530 also inversely transforms the transform coefficients of the corresponding subblock into the spatial domain from the frequency domain to reconstruct the residual signals and fills an area, which is not inversely transformed, with a value of “0” as the residual signals to generate a final residual block for the current block.

Further, when the MTS is applied, the inverse transformer 530 determines the transform index or the transform matrix to be applied in each of the horizontal and vertical directions by using the MTS information (mts_idx) signaled from the video encoding apparatus. The inverse transformer 530 also performs inverse transform for the transform coefficients in the transform block in the horizontal and vertical directions by using the determined transform function.

The predictor 540 may include an intra predictor 542 and an inter predictor 544. The intra predictor 542 is activated when the prediction type of the current block is the intra prediction, and the inter predictor 544 is activated when the prediction type of the current block is the inter prediction.

The intra predictor 542 determines the intra prediction mode of the current block among the plurality of intra prediction modes from the syntax element for the intra prediction mode extracted from the entropy decoder 510. The intra predictor 542 also predicts the current block by using neighboring reference pixels of the current block according to the intra prediction mode.

The inter predictor 544 determines the motion vector of the current block and the reference picture to which the motion vector refers by using the syntax element for the inter prediction mode extracted from the entropy decoder 510.

The adder 550 reconstructs the current block by adding the residual block output from the inverse transformer 530 and the prediction block output from the inter predictor 544 or the intra predictor 542. Pixels within the reconstructed current block are used as a reference pixel upon intra predicting a block to be decoded afterwards.

The loop filter unit 560 as an in-loop filter may include a deblocking filter 562, an SAO filter 564, and an ALF 566. The deblocking filter 562 performs deblocking filtering a boundary between the reconstructed blocks in order to remove the blocking artifact, which occurs due to block unit decoding. The SAO filter 564 and the ALF 566 perform additional filtering for the reconstructed block after the deblocking filtering in order to compensate differences between the reconstructed pixels and original pixels, which occur due to lossy coding. The filter coefficients of the ALF are determined by using information on filter coefficients decoded from the bitstream.

The reconstructed block filtered through the deblocking filter 562, the SAO filter 564, and the ALF 566 is stored in the memory 570. When all blocks in one picture are reconstructed, the reconstructed picture may be used as a reference picture for inter predicting a block within a picture to be encoded afterwards.

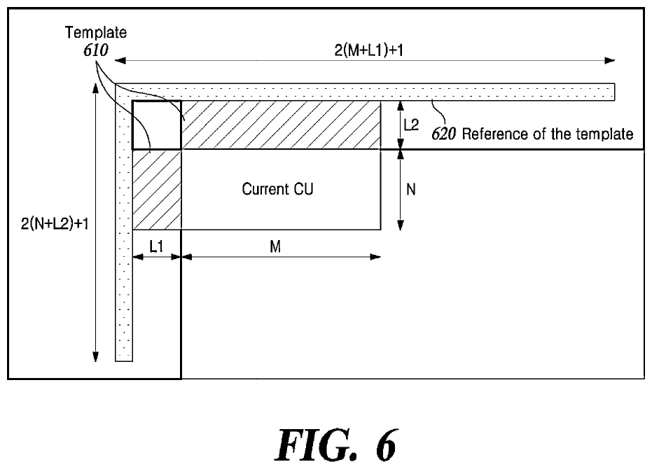

FIG. 6 a diagram illustrating a template used to derive a template-based intra-prediction mode, and a reference pixel of the template, according to at least one embodiment of the present disclosure. Intra-prediction mode may be synonymous with intra-screen prediction mode. Inter-prediction mode may be synonymous with inter-screen prediction mode. By using the template adjacent to the current block, the intra-prediction mode of the current block may be derived. By applying the directionality of all candidate modes in a Most Probable Mode (MPM) list to a reference pixel in the template, a prediction template may be generated. The Sum of Absolute Transformed Differences (SATD) between the pixels of the generated prediction template and the pixels of the already reconstructed template may be calculated. The mode that produces the least sum of absolute transformed differences among the MPM candidate modes is the intra-prediction mode of the current block derived by a template-based method of deriving the intra-prediction mode. The intra-prediction mode of the current block derived by the template-based method of deriving the intra-prediction mode may be used as an additional mode for the current Coding Unit (CU) block.

From the Sequence Parameter Set (SPS), a flag may be signaled indicating the use or non-use of the template-based method of deriving the intra-prediction mode. If the template-based method of deriving the intra-prediction mode is used, the present embodiment may use a CU-level flag to express whether to apply the template-based method of deriving the intra-prediction mode at the CU level. If the current CU block uses the template-based based method of deriving the intra-prediction mode, the decoding apparatus may use the template-based method of deriving the intra-prediction mode to derive information on the intra-prediction mode of the current CU block. This may allow the omission of signaling of the syntax associated with the intra-prediction mode for the remaining luminance components.

Referring to FIG. 6, a template 610 used in the template-based method of deriving the intra-prediction mode may be adjacent to the top and left of the current block. A template's reference pixel 620 that is applied with the directionality of all candidate modes in the MPM list may exist adjacent to the template 610. The directionality of all candidate modes in the MPM list may be applied to the template's reference pixel 620 to generate a prediction template.

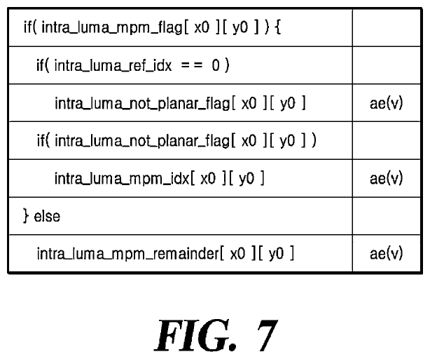

FIG. 7 is a diagram illustrating a syntax associated with an intra-prediction mode of the current block, according to at least one embodiment of the present disclosure. An MPM list may be generated by using the intra-prediction mode of a reference block that is neighboring the current block. The present embodiment may calculate the template-based sum of absolute transformed differences for each of the candidate modes in the generated MPM list. Computing the template-based sum of absolute transformed differences for the candidate modes may mean applying the directionality of the candidate modes to the reference pixel of the template to generate a predicted template pixel and computing the sum of absolute transformed differences between the generated predicted template pixel and the reconstructed template pixel. The present embodiment may use the respective calculations of the template-based sum of absolute transformed differences for the candidate mode to reorder the candidate modes in the MPM list. The candidate mode used to generate the small sum of absolute transformed differences may be placed at the front of the MPM list. The candidate modes used to generate the large sum of absolute transformed differences may be placed at the back of the MPM list. This reordering of the candidate modes in the MPM list can improve encoding efficiency.

The MPM list may be generated by using the intra-prediction mode of a reference block neighboring the current block. Regardless of the intra-prediction mode of the reference block neighboring the current block, the planar mode may be added as the first candidate mode in the MPM list. When reordering the candidate modes in the MPM list, the template-based sum of absolute transformed differences for the remaining candidate modes, excluding the planar mode, may be calculated. The first candidate mode in the MPM list may be fixed as the planar mode and reordering may be performed by using the template-based sum of absolute transformed differences for the remaining candidate modes.

Referring to FIG. 7, the following flags may be signaled: intra_luma_mpm_flag, intra_luma_not_planar_flag, intra_luma_mpm_idx, and intra_luma_mpm_remainder, which are associated with the intra-prediction mode of the current block. The intra_luma_not_planar_flag may correspond to a flag related to the planar mode. When reordering the candidate modes in the MPM list, intra_luma_not_planar_flag may be signaled since the planar mode is fixed as the first candidate mode.

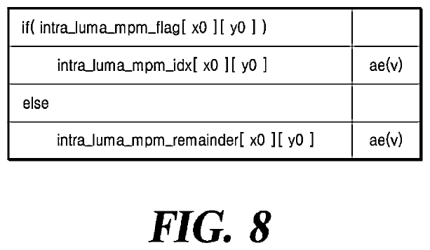

FIG. 8 is a diagram illustrating a syntax associated with an intra-prediction mode of the current block, according to another embodiment of the present disclosure. When reordering candidate modes in the MPM list, the template-based sum of absolute transformed differences for all candidate modes, including planar mode in the MPM list, may be calculated. By using the template-based sum of absolute transformed differences for all candidate modes, including the planar mode, the present embodiment may reorder the candidate modes in the MPM list. The MPM list may be reordered by placing the candidate modes further forward in order, with priority given to the candidate mode utilized to generate a smaller calculated sum of absolute transformed differences.

Referring to FIG. 8, the flags of intra_luma_mpm_flag, intra_luma_mpm_idx, and intra_luma_mpm_remainder, which are associated with the intra-prediction mode of the current block, may be signaled. When reordering candidate modes in the MPM list, the signaling of intra_luma_not_planar_flag may be omitted because the template-based sum of absolute transformed differences for the planar mode is calculated and used. Information about the planar mode may be sent using intra_luma_mpm_idx. The omission of signaling the intra_luma_not_planar_flag can simplify the syntax structure.

In the binarization of intra_luma_mpm_idx signaled in FIG. 7, the number of cMax may be equal to 4. In the binarization of intra_luma_mpm_idx signaled in FIG. 8, the number of cMax may be equal to 5, as the signaled intra_luma_mpm_idx needs to process information on the planar mode.

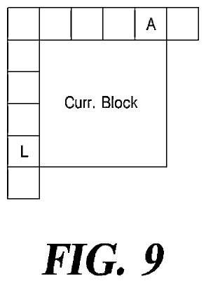

FIG. 9 is a diagram illustrating the current block's neighboring reference blocks used to generate a Most Probable Mode (MPM) list, according to at least one embodiment of the present disclosure. Based on the intra-prediction modes of the reference blocks neighboring the current block, the present embodiment may determine whether to use the template-based method of deriving the intra-prediction mode.

Referring to FIG. 9, an A reference block adjacent to the top of the current block and an L reference block adjacent to the left of the current block may be used to generate the MPM list. The intra-prediction mode of the A reference block may mean A mode. The intra-prediction mode of the L reference block may mean L mode. MPM lists may be generated by using both A mode and L mode. The candidate modes in the generated MPM list are highly correlated with the A mode and L mode. Based on the A mode and L mode and by using the template-based sum of absolute transformed differences for the candidate modes, the present embodiment may determine whether or not to use the method of reordering the candidate modes in the MPM list.

The present embodiment provides scheme 1 as follows. When the A mode and L mode are the same, the neighboring blocks of the current block are likely to have one directional mode or one non-directional mode. In this case, the intra-prediction mode of the current block may have a high probability of having the same or similar intra-prediction modes as the A mode and L mode. The intra-prediction mode of the current block may be effectively encoded by using the MPM lists generated by the A mode and L mode. Therefore, when the A mode and L mode are the same, the present embodiment may not use the method of reordering the candidate modes in the MPM list with the template-based sum of absolute transformed differences for the candidate modes.

The present embodiment provides scheme 2 as follows. There are three cases where both A mode and L mode are non-directional: when A mode and L mode are both planar modes, when A mode and L mode are both DC modes, and when A mode and L mode are planner and DC modes, respectively. If the intra-prediction modes of the reference blocks neighboring the current block are all non-directional, the current block's neighbors may not have directional information. If the intra-prediction modes of the reference blocks neighboring the current block are all non-directional, the MPM list may be composed by using a particular default mode. If the MPM list is composed by using the default mode, reordering of the candidate modes in the MPM list with the template-based sum of absolute transformed differences for the candidate modes may be less efficient for encoding. Accordingly, if both A mode and L mode are non-directional, the present embodiment may omit to use the method of reordering the candidate modes in the MPM list with the template-based sum of absolute transformed differences for the candidate modes.

Scheme 1 may omit to use the method of reordering the candidate modes in the MPM list with the template-based sum of absolute transformed differences for the candidate modes if and only if the A mode and L mode are identical to be non-directional. Additionally, scheme 1 may omit to use the method of reordering candidate modes in the MPM list with the template-based sum of absolute transformed differences for the candidate modes if and only if the A mode and L mode are identical to be directional. Additionally, when the A mode and L mode are the same regardless of being directional or non-directional, scheme 1 may omit the method of reordering candidate modes in the MPM list with the template-based sum of absolute transformed differences for candidate modes.

Scheme 1 and scheme 2 may each be used independently or in combination. Scheme 1 alone may be applied to determine whether to use the method of reordering the candidate modes in the MPM list with the template-based sum of absolute transformed differences for the candidate modes. Scheme 2 alone may be applied to determine whether to use the method of reordering the candidate modes in the MPM list with the template-based sum of absolute transformed differences for the candidate modes. Scheme 1 and scheme 2 may be combined to determine whether to use the method of reordering the candidate modes in the MPM list with the template-based sum of absolute transformed differences for the candidate modes.

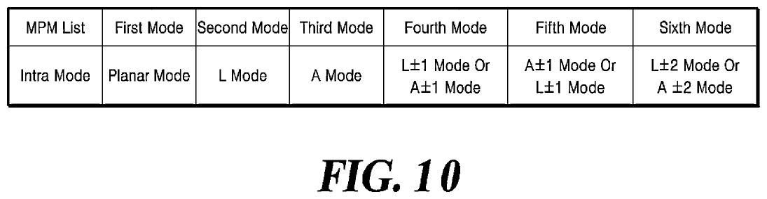

FIG. 10 is a diagram illustrating a generated MPM list when the intra-prediction modes of two neighboring reference blocks of the current block are different directional modes, according to at least one embodiment of the present disclosure. The candidate modes in the MPM list may be reordered by using the correlation of the intra-prediction modes of the reference blocks neighboring the current block. The candidate modes in the MPM list may be reordered by using the sum of absolute transformed differences of the intra-prediction modes of the reference blocks neighboring the current block. The MPM list may be generated in three distinct cases, based on the A mode and L mode in FIG. 9.

The first case may be when the A mode and L mode have different directional modes. The second case may be when the A mode and L mode have the same directional mode, or the A mode and L mode have a directional mode and a non-directional mode respectively, or the A mode and L mode have a non-directional mode and a directional mode respectively. The third case may be when both A mode and L mode have a non-directional mode.

Referring to FIG. 10, where A mode and L mode of FIG. 9 are different directional modes, the MPM list may be composed of a first mode being a planar mode, a second mode being the L mode, a third mode being the A mode, a fourth mode being an L±1 mode or an A±1 mode, a fifth mode being an A±1 mode or an L±1 mode, and a sixth mode being an L±2 mode or an A±2 mode. A−1 mode, A+1 mode, A−2 mode, and A+2 mode may represent −1 mode, +1 mode, −2 mode, and +2 mode, respectively, relative to the A mode. L−1 mode, L+1 mode, L−2 mode, and L+2 mode may represent −1 mode, +1 mode, −2 mode, and +2 mode, respectively, relative to the L mode.

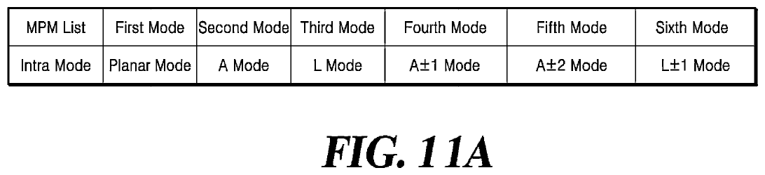

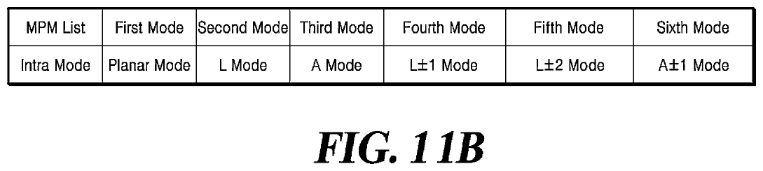

FIGS. 11A and 11B are diagrams illustrating a method of reordering an MPM list when the intra-prediction modes of two neighboring reference blocks of the current block are different directional modes, according to at least one embodiment of the present disclosure. If the A mode and L mode of FIG. 9 are different directional modes, an MPM list may be generated as shown in FIG. 10. The present embodiment may calculate the template-based sum of absolute transformed differences for the second mode, L mode, and the third mode, A mode, from the MPM list. The calculated sum of absolute transformed differences may be used to determine the order of priority of the candidate modes in the MPM list. The calculated sum of absolute transformed differences may be used to reorder the candidate modes in the MPM list. SATD_{X} may represent the template-based Sum of Absolute Transformed Differences (SATD) for arbitrary X modes. Threshold and Threshold_1 may each mean an arbitrarily set threshold value. Threshold and Threshold_1 satisfy Threshold>0 and Threshold_1>0. For example, SATD_{Planar} may represent the template-based sum of absolute transformed differences for the planar mode and SATD₅₀ may represent the template-based sum of absolute transformed differences for the 50th mode.

Referring to FIG. 11A, a sum SATD_{A} of absolute transformed differences for the A mode, may be calculated. A sum SATD_{L} of absolute transformed differences for the L mode may be calculated. If SATD_{A}≤Threshold*SATD_{L}, the MPM list may be reordered. The reordered MPM list may be composed of the first mode being the planar mode, the second mode being the A mode, the third mode being the L mode, the fourth mode being the A±1 mode, the fifth mode being the A±2 mode, and the sixth mode being the L±1 mode.

Referring to FIG. 11B, the sum SATD_{A} of absolute transformed differences for the A mode, may be calculated. The sum SATD_{L} of absolute transformed differences for the L mode may be calculated. If SATD_{A}>Threshold*SATD_{L}, the MPM list may be reordered. The reordered MPM list may be composed of the first mode being the planar mode, the second mode being the L mode, the third mode being the A mode, the fourth mode being the L±1 mode, the fifth mode being the L±2 mode, and the sixth mode being the A±1 mode. Then, the sum of absolute transformed differences for the A mode and L mode may be compared. Priority may be given to a candidate mode used to calculate the smaller sum of absolute transformed differences among the calculated sum of absolute transformed differences.

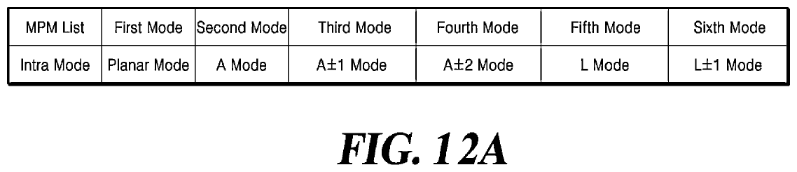

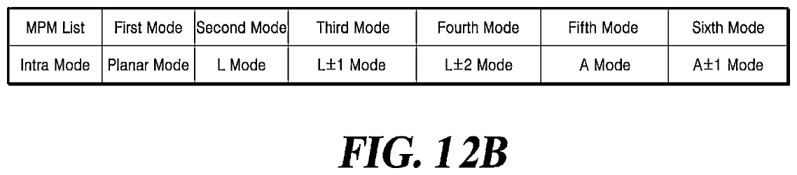

FIGS. 12A and 12B are diagrams illustrating a method of reordering an MPM list when the intra-prediction modes of two neighboring reference blocks of the current block are different directional modes, according to another embodiment of the present disclosure.

Referring to FIG. 12A, the sum SATD_{A} of absolute transformed differences for the A mode may be calculated. The sum SATD_{L} of absolute transformed differences for the L mode may be calculated. If SATD_{A}≤Threshold*SATD_{L}, the MPM list may be reordered. The reordered MPM list may be composed of the first mode being the planar mode, the second mode being the A mode, the third mode being the A±1 mode, the fourth mode being the A±2 mode, the fifth mode being the L mode, and the sixth mode being the L±1 mode.

Referring to FIG. 12B, the sum SATD_{A} of absolute transformed differences for the A mode may be calculated. The sum SATD_{L} of absolute transformed differences for the L mode may be calculated. If SATD_{A}>Threshold*SATD_{L}, the MPM list may be reordered. The reordered MPM list may be composed of the first mode being the planar mode, the second mode being the L mode, the third mode being the L±1 mode, the fourth mode being the L±2 mode, the fifth mode being the A mode, and the sixth mode being the A±1 mode.

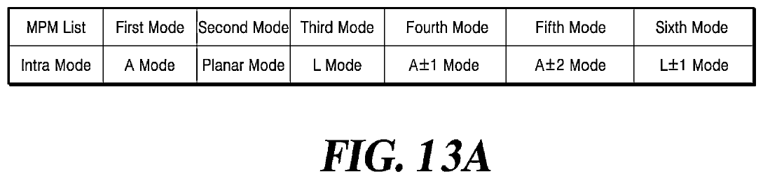

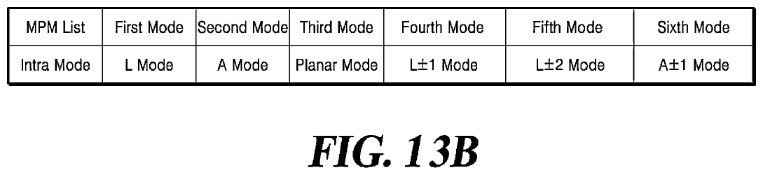

FIG. 13A and FIG. 13B are diagrams illustrating a method of reordering an MPM list when the intra-prediction modes of two neighboring reference blocks of the current block are different directional modes, according to yet another embodiment of the present disclosure. If the A mode and L mode of FIG. 9 are different directional modes, an MPM list may be generated as shown in FIG. 10. From the MPM list, the present embodiment may calculate the template-based sum of absolute transformed differences for the planar mode and the second mode, L mode, and the third mode, A mode. By using the calculated sum of absolute transformed differences, the present embodiment may determine the order of priority of the candidate modes in the MPM list. Using the calculated sum of absolute transformed differences, the candidate modes in the MPM list may be reordered.

Referring to FIG. 13A, a sum SATD_{Planar} of the absolute transformed differences for the planar mode may be calculated. A sum SATD_{A} of absolute transformed differences for the A mode may be calculated. The sum SATD_{L} of absolute transformed differences for L mode may be calculated. If Threshold_2*SATD_{A}<Threshold_1*SATD_{Planar}<Threshold_3*SATD_{L}, the MPM list may be reordered. The reordered MPM list may be composed of the first mode being the A mode, the second mode being the planar mode, the third mode being the L mode, the fourth mode being the A±1 mode, the fifth mode being the A±2 mode, and the sixth mode being the L±1 mode.

Referring to FIG. 13B, the sum SATD_{Planar} of absolute transformed differences for the planar mode may be calculated. The sum SATD_{A} of absolute transformed differences for the A mode may be calculated. The sum SATD_{L} of absolute transformed differences for L mode may be computed. If Threshold_3*SATD_{L}<Threshold_2*SATD_{A}<Threshold_1*SATD_{Planar}, the MPM list may be reordered. The reordered MPM list may be composed of the first mode as L mode, the second mode as A mode, the third mode as planar mode, the fourth mode as L±1 mode, the fifth mode as L±2 mode, and the sixth mode as A±1 mode. Here, Threshold_1, Threshold_2, and Threshold_3 may satisfy Threshold_1>0, Threshold_2>0, and Threshold_3>0, respectively.

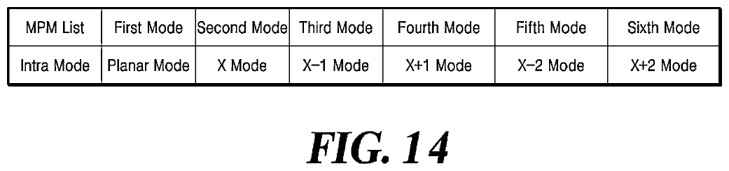

FIG. 14 is a diagram illustrating a generated MPM list when the intra-prediction modes of two neighboring reference blocks of the current block are the same directional mode, or when they are directional and non-directional modes, respectively, according to at least one embodiment of the present disclosure.

Referring to FIG. 14, an MPM list may be generated when A mode and L mode of FIG. 9 are the same directional mode, or when A mode and L mode of FIG. 9 are directional and non-directional modes, respectively, or when A mode and L mode of FIG. 9 are non-directional and directional modes, respectively. Here, the directional mode is an X-mode and may correspond to any directional mode. The MPM list may be composed of a first mode being a planar mode, a second mode being an X mode, a third mode being an X−1 mode, a fourth mode being an X+1 mode, a fifth mode being an X−2 mode, and a sixth mode being an X+2 mode.

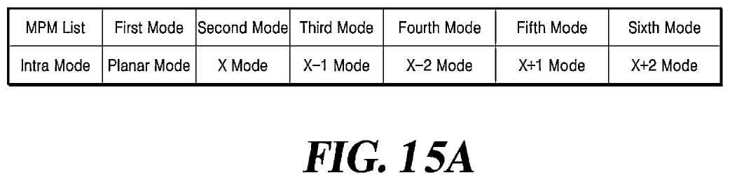

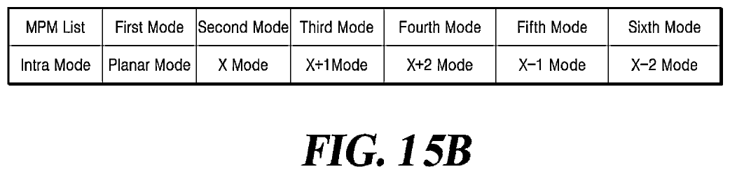

FIGS. 15A and 15B are diagrams illustrating a method of reordering an MPM list, according to at least one embodiment of the present disclosure, when the intra-prediction modes of two neighboring reference blocks of the current block are the same directional mode, or when they are a directional mode and a non-directional mode, respectively. An MPM list may be generated as shown in FIG. 14 if the A mode and L mode of FIG. 9 are the same directional mode, or if the A mode and L mode of FIG. 9 are directional and non-directional modes, respectively, or if the A mode and L mode of FIG. 9 are non-directional and directional modes, respectively. From the MPM list, the present embodiment may calculate the template-based sum of absolute transformed differences for the third mode, X−1 mode, and the fourth mode, X+1 mode. The calculated sum of absolute transformed differences may be used to determine the order of priority of the candidate modes in the MPM list. The calculated sum of absolute transformed differences may be used to reorder the candidate modes in the MPM list.

Referring to FIG. 15A, a sum SATD_{X-1} of the absolute transformed differences for the X−1 mode may be calculated. A sum SATD_{X+1} of the absolute transformed differences for the X+1 mode may be calculated. If SATD_{X-1}≤Threshold*SATD_{X+1}, the MPM list may be reordered. The reordered MPM list may be composed of the first mode being the planar mode, the second mode being the X mode, the third mode being the X−1 mode, the fourth mode being the X−2 mode, the fifth mode being the X+1 mode, and the sixth mode being the X+2 mode.

Referring to FIG. 15B, the sum SATD_{X-1} of absolute transformed differences for the X−1 mode may be calculated. The sum SATD_{X+1} of absolute transformed differences for the X+1 mode may be calculated. If SATD_{X-1}>Threshold*SATD_{X+1}, the MPM list may be reordered. The reordered MPM list may be composed of the first mode being the planar mode, the second mode being the X mode, the third mode being the X+1 mode, the fourth mode being the X+2 mode, the fifth mode being the X−1 mode, and the sixth mode being the X−2 mode. Then, the sum of absolute transformed differences for the X−1 mode and the X+1 mode may be compared. Priority may be given to the candidate mode associated with the mode that was used to calculate the smaller of the calculated sum of absolute transformed differences.

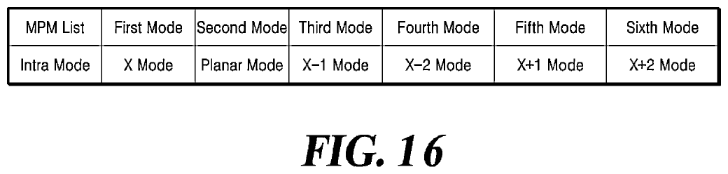

FIG. 16 is a diagram illustrating a method of reordering an MPM list, according to another embodiment of the present disclosure, when the intra-prediction modes of two neighboring reference blocks of the current block are the same directional mode, or when they are a directional mode and a non-directional mode, respectively. An MPM list may be generated as shown in FIG. 14 if A mode and L mode of FIG. 9 are the same directional mode, or if A mode and L mode of FIG. 9 are directional and non-directional modes, respectively, or if A mode and L mode of FIG. 9 are non-directional and directional modes, respectively. From the MPM list, the present embodiment may calculate the template-based sum of absolute transformed differences for the first mode, the planar mode, and the second mode, the X mode. The calculated sum of absolute transformed differences may be used to determine the order of priority of the candidate modes in the MPM list. The calculated sum of absolute transformed differences may be used to reorder the candidate modes in the MPM list.

Referring to FIG. 16, the sum SATD_{Planar} of absolute transformed differences for the planar mode may be calculated. A sum SATD_{X} of absolute transformed differences for the X mode may be calculated. If SATD_{X}<Threshold*SATD_{Planar}, the MPM list may be reordered. The reordered MPM list may be composed of the first mode being the X mode, the second mode being the planar mode, the third mode being the X−1 mode, the fourth mode being the X−2 mode, the fifth mode being the X+1 mode, and the sixth mode being the X+2 mode.

Another embodiment may calculate the sum SATD_{Planar} of the absolute transformed differences for the planar mode. The sum SATD_{X} of absolute transformed differences for the X mode may be calculated. Based on the sums SATD_{Planar} and SATD_{X}, the priority of the planar mode and the X mode may be determined. The sum SATD_{X-1} of absolute transformed differences for X−1 mode may be calculated. The sum SATD_{X+1} of absolute transformed differences for the X+1 mode may be computed. Based on the sums SATD_{X-1} and SATD_{X+1}, a prioritization may be determined for the X−1 and X+1 modes. Based on the sums SATD_{X-1} and SATD_{X+1}, a priority may be determined for X-2 mode and X+2 mode. Based on the determined priorities, the MPM list may be reordered.

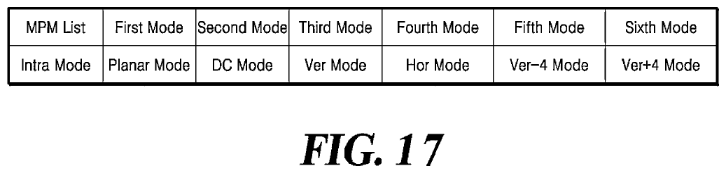

FIG. 17 is a diagram illustrating a generated MPM list when the intra-prediction modes of two neighboring reference blocks of the current block are both non-directional modes, according to at least one embodiment of the present disclosure.

Referring to FIG. 17, if the A mode and L mode of FIG. 9 are both non-directional modes, an MPM list may be generated. The MPM list may be composed of a first mode being a planar mode, a second mode being a DC mode, a third mode being a Ver mode, a fourth mode being a Hor mode, a fifth mode being a Ver−4 mode, and a sixth mode being a Ver+4 mode.

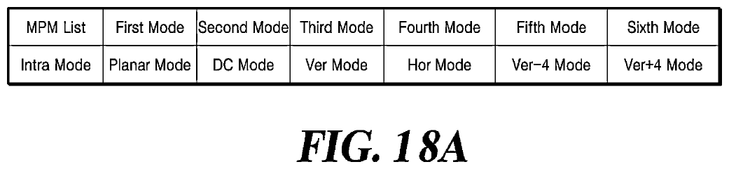

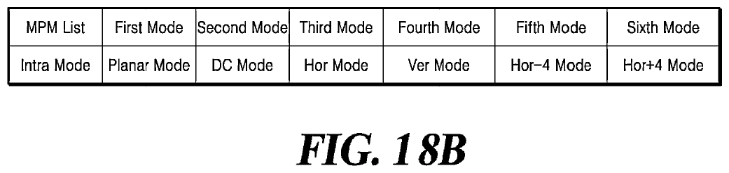

FIGS. 18A and 18B are diagrams illustrating a method of reordering an MPM list when the intra-prediction modes of two neighboring reference blocks of the current block are both non-directional modes, according to at least one embodiment of the present disclosure. If the A mode and L mode of FIG. 9 are non-directional modes, an MPM list may be generated as shown in FIG. 17. From the MPM list, the present embodiment may calculate the template-based sum of absolute transformed differences for the third mode, Ver, and the fourth mode, Hor. The calculated sum of absolute transformed differences may be used to determine the order of priority of the candidate modes in the MPM list. Using the calculated sum of absolute transformed differences, the candidate modes in the MPM list may be reordered.

Referring to FIG. 18A, a sum SATD_{Ver} of absolute transformed differences for the Ver mode may be calculated. A sum SATD_{Hor} of absolute transformed differences for the Hor mode may be calculated. If SATD_{Ver}≤Threshold*SATD_{Hor}, the MPM list may be reordered. The reordered MPM list may be composed of the first mode as the planar mode, the second mode as the DC mode, the third mode as the Ver mode, the fourth mode as the Hor mode, the fifth mode as the Ver−4 mode, and the sixth mode as the Ver+4 mode. Then, a first scheme may prioritize the Ver mode and Hor mode based on the sums SATD_{Ver} and SATD_{Hor}. In a second scheme, the fifth mode and sixth mode may be assigned Ver−4 mode and Ver+4 mode based on the sums SATD_{Ver} and SATD_{Hor}. The first and second schemes may each be used independently. Alternatively, the first and second schemes may be combined and used together.

Referring to FIG. 18B, the sum SATD_{Ver} of absolute transformed differences for the Ver mode may be calculated. The sum SATD_{Hor} of absolute transformed differences for the Hor mode may be calculated. If SATD_{Ver}>Threshold*SATD_{Hor}, the MPM list may be reordered. The reordered MPM list may be composed of the first mode as the planar mode, the second mode as the DC mode, the third mode as the Hor mode, the fourth mode as the Ver mode, the fifth mode as the Hor−4 mode, and the sixth mode as the Hor+4 mode. Then, a first scheme may prioritize the Ver and Hor modes based on the sums SATD_{Ver} and SATD_{Hor}. In a second scheme, the fifth mode and sixth mode may be assigned Hor−4 mode and Hor+4 mode based on the sums SATD_{Ver} and SATD_{Hor}. The first and second schemes may each be used independently. Alternatively, the first and second schemes may be combined and used together.

Another embodiment may calculate the sum SATD_{Planar} of the absolute transformed differences for the planar mode. A sum SATD_{DC} of absolute transformed differences for the DC mode may be calculated. If SATD_{Planar}≤Threshold*SATD_{DC}, the planar mode may be placed first in the MPM list, followed by the DC mode. If SATD_{Planar}>Threshold*SATD_{DC}, the DC mode may be placed first in the MPM list, followed by the planar mode. These other embodiments, as well as the previously described embodiments in FIGS. 18A and 18B, may each be used independently. The embodiments described above in FIGS. 18A and 18B and the other embodiments may be used in combination.

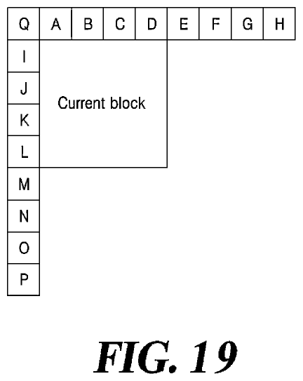

FIG. 19 is a diagram illustrating neighboring blocks of the current block, according to at least one embodiment of the present disclosure. Calculating a template-based sum of absolute transformed differences for the intra-prediction mode of the reference block may mean generating a prediction template by applying the directionality of the intra-prediction mode of the reference block to reference pixels in the template and may mean calculating sum of absolute transformed differences between pixels in the generated prediction template and pixels in the reconstructed template.

Referring to FIG. 19, there may be top blocks A through H, left blocks I through P, and top-left block Q that are neighbors of the current block. The template-based sum of absolute transformed differences may be calculated for the intra-prediction modes of the top blocks A through H, left blocks I through P, and top-left block Q. Beginning with the intra-prediction mode used to produce a smaller sum of the calculated sum of absolute transformed differences, the intra-prediction modes may be prioritized to be added to the MPM list. Here, the number and position of the top blocks, left blocks, and top-left block(s) used may be arbitrarily determined. The present disclosure utilizes different intra-prediction modes of reference blocks that are neighbors to the current block, thereby improving the encoding efficiency. The template-based sum of absolute transformed differences may be calculated exclusively for different intra-prediction modes of reference blocks neighboring the current block. In other words, the template-based sum of absolute transformed differences may be calculated only for new intra-prediction modes through redundancy checking.

For example, if no planar mode is present in the intra-prediction modes of reference blocks neighboring the current block, the present disclosure may calculate the template-based sum of absolute transformed differences for the planar mode. An MPM list may be generated by taking account of the template-based sum of absolute transformed differences for the planar mode.

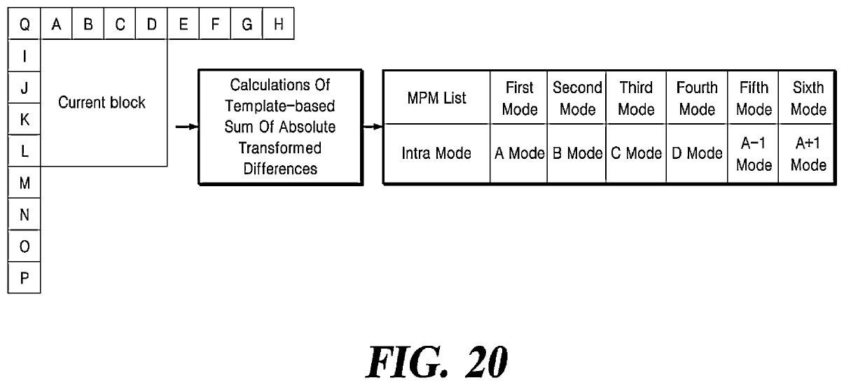

FIG. 20 is a diagram illustrating a method of generating an MPM list with the sum of absolute transformed differences for intra-prediction modes of neighboring blocks of the current block, according to at least one embodiment of the present disclosure. In FIG. 19, the template-based sum of absolute transformed differences for the intra-prediction modes of top blocks A through H, left blocks I through P, and top-left block Q may be calculated. Beginning with the intra-prediction mode used to produce a smaller sum of the sum of absolute transformed differences, the intra-prediction modes may be prioritized to be added to the MPM list. The MPM list may not be fully populated if the MPM list is added beginning with the intra-prediction mode used to produce a smaller sum of the sum of absolute transformed differences. For example, if the current block has a total of four intra-prediction modes from neighboring reference blocks, the MPM list, which is composed using only four intra-prediction modes, needs two more candidate modes. In this case, candidate modes may be added to the MPM list to equal the number of candidate modes that are lacking.

Referring to FIG. 20, a total of four non-duplicate intra-prediction modes may occur from the intra-prediction modes of top blocks A through H, left blocks I through P, and top left block Q. The non-duplicate intra-prediction modes may correspond to A mode, B mode, C mode, and D mode. The template-based sum of absolute transformed differences for mode A, mode B, mode C, and mode D may be calculated. The calculations of the template-based sum of absolute transformed differences may be added to the MPM list in such an order as the least calculation first and the largest calculation the last. The MPM list may be added with the calculations of the template-based sum of absolute transformed differences in the following order: A mode, B mode, C mode, and D mode. Accordingly, the MPM list may need a fifth mode and a sixth mode.

Using the first mode, an A mode, an A−1 mode, and an A+1 mode may be generated. The A−1 mode and the A+1 mode may be checked for duplicates against all candidate modes in the MPM list. If there are no duplicate modes, the A−1 mode and the A+1 mode may be assigned as the fifth and sixth modes. The A−1 and A+1 modes may be added to the fifth and sixth modes in the MPM list in any order, regardless of priority. If duplicate modes occur, B−1 and B+1 modes may be generated by using the second mode, B mode. The B−1 and B+1 modes may be checked for duplicates against all candidate modes in the MPM list. If there are no duplicate modes, the B−1 and B+1 modes may be assigned as the fifth and sixth modes. The B−1 and B+1 modes may be added to the fifth and sixth modes in the MPM list in any order of priority.

If the MPM list is not fully populated by using B−1 mode and B+1 mode, a third mode, C mode, may be used to generate C−1 mode and C+1 mode. The C−1 and C+1 modes may be checked for duplicates against all candidate modes in the MPM list. If there are no duplicate modes, the C−1 and C+1 modes may be assigned as the fifth and sixth modes. The C−1 and C+1 modes may be added to the fifth and sixth modes in the MPM list at random, regardless of priority. This can be done until all candidate modes in the MPM list are filled. During this process, no ±1 modes are calculated for non-directional modes.

If this process does not populate all of the candidate modes in the MPM list, an A−2 mode and an A+2 mode may be generated by using the first mode, the A mode. The A−2 and A+2 modes may be checked for duplicates against all candidate modes in the MPM list. If there are no duplicate modes, the A−2 and A+2 modes may be added to the MPM list in any order of priority. The modes to be added may be generated by sequentially calculating ±1, ±2, ±3, . . . to the forwardly located candidate modes in the MPM list. The modes to be added are checked for duplicates to form the MPM list. This process ends when all candidate modes in the MPM list are populated.

If the non-duplicate intra-prediction modes from the intra-prediction modes in top blocks A through H, left blocks I through P, and top left block Q are all non-directional modes, the MPM list may be composed of the first mode being the planar mode, the second mode being the DC mode, the third mode being the Ver mode, the fourth mode being the Hor mode, the fifth mode being the Ver−4 mode, and the sixth mode being the Ver+4 mode. The sum of absolute transformed differences for the candidate modes in the generated MPM list may be calculated. By using the calculated sum of absolute transformed differences, the candidate modes in the MPM list may be reordered.

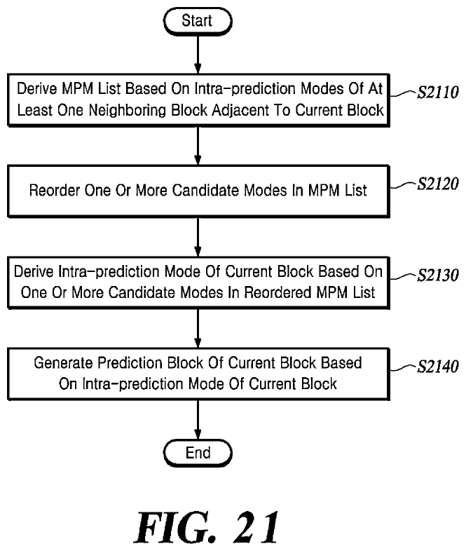

FIG. 21 is a diagram illustrating a video decoding process according to at least one embodiment of the present disclosure.

Referring to FIG. 21, the decoding apparatus may derive an MPM list based on an intra-prediction mode of at least one neighboring block adjacent to the current block (S2110). This step of deriving the MPM list may include generating prediction pixels by applying one or more intra-prediction modes of at least one neighboring block adjacent to the current block to reference pixels of a first region adjacent to the current block, calculating sum of absolute transformed differences between the prediction pixels and reconstructed pixels in the first region, and deriving the MPM list based on the calculated sum of absolute transformed differences. Here, the MPM list may be derived with priority given to an intra-prediction mode utilized to generate a prediction pixel that causes the least sum among the calculated sum of absolute transformed differences. For the MPM list thus derived, the video decoding process may omit the reordering of the one or more candidate modes in the MPM list with a template-based sum of absolute transformed differences for the candidate modes. The MPM list thus derived may be used to derive an intra-prediction mode of the current block.

When the MPM list is not fully populated, the video decoding process may further include deriving two intra-prediction modes by using an intra-prediction mode utilized to generate a prediction pixel that causes the least sum among the calculated sum of absolute transformed differences and deriving the MPM list based on the two intra-prediction modes.

The decoding apparatus may reorder the one or more candidate modes in the MPM list (S2120). The step of reordering the one or more candidate modes in the MPM list may include generating prediction pixels by applying the one or more candidate modes in the MPM list to the reference pixels in the first region adjacent to the current block. The step of reordering the one or more candidate modes may include calculating sum of absolute transformed differences between the prediction pixels and reconstructed pixels in the first region. The step of reordering the one or more candidate modes may include reordering the one or more candidate modes in the MPM list based on the calculated sum of absolute transformed differences. Here, the one or more candidate modes in the MPM list may include a planar mode, and the MPM list is reordered with priority given to a candidate mode utilized to generate a prediction pixel that causes the least sum among the calculated sum of absolute transformed differences. The first region may correspond to at least one of a top region, a left region, and a top-left region of the current block.

The step of reordering the one or more candidate modes in the MPM list may include generating, when intra-prediction modes of two neighboring blocks adjacent to the current block are different directional modes, prediction pixels by applying the intra-prediction modes of the two neighboring blocks adjacent to the current block to reference pixels in the first region adjacent to the current block. The step of reordering the one or more candidate modes may include calculating sum of absolute transformed differences between the prediction pixels and reconstructed pixels in the first region. The step of reordering the one or more candidate modes may include reordering the one or more candidate modes in the MPM list based on the calculated sum of absolute transformed differences. Here, the intra-prediction modes of the two neighboring blocks adjacent to the current block may correspond to the intra-prediction modes used to derive the MPM list.

The step of reordering the one or more candidate modes in the MPM list may include generating, when intra-prediction modes of two neighboring blocks adjacent to the current block are different directional modes, prediction pixels by applying the intra-prediction modes of the two neighboring blocks adjacent to the current block and a planar mode, to reference pixels in the first region adjacent to the current block. The step of reordering the one or more candidate modes may include calculating sum of absolute transformed differences between the prediction pixels and reconstructed pixels in the first region. The step of reordering the one or more candidate modes may include reordering the one or more candidate modes in the MPM list based on the calculated sum of absolute transformed differences. Here, the intra-prediction modes of two neighboring blocks adjacent to the current block may correspond to the intra-prediction modes used to derive the MPM list.

The step of reordering the one or more candidate modes in the MPM list may include generating, when intra-prediction modes of two neighboring blocks adjacent to the current block are equal to a directional mode, prediction pixels by applying at least one of two modes, derived from the directional mode, a planar mode, and the directional mode, to reference pixels in the first region adjacent to the current block. The step of reordering the one or more candidate modes may also include calculating sum of absolute transformed differences between the prediction pixels and reconstructed pixels in the first region. The step of reordering the one or more candidate modes may also include reordering the one or more candidate modes in the MPM list based on the calculated sum of absolute transformed differences. Here, the intra-prediction modes of the two neighboring blocks adjacent to the current block may correspond to the intra-prediction modes used to derive the MPM list.

The step of reordering the one or more candidate modes in the MPM list may include generating, when intra-prediction modes of two neighboring blocks adjacent to the current block are a directional mode and a non-directional mode, respectively, prediction pixels by applying at least one of two modes, derived from the directional mode, a planar mode, and the directional mode, to reference pixels in the first region adjacent to the current block. The step of reordering the one or more candidate modes may also include calculating sum of absolute transformed differences between the prediction pixels and reconstructed pixels in the first region. The step of reordering the one or more candidate modes may also include reordering the one or more candidate modes in the MPM list based on the calculated sum of absolute transformed differences. Here, the intra-prediction modes of two neighboring blocks adjacent to the current block may correspond to the intra-prediction modes used to derive the MPM list.

The step of reordering the one or more candidate modes in the MPM list may include generating, when intra-prediction modes of two neighboring blocks adjacent to the current block are non-directional modes, prediction pixels by applying at least one of a planar mode, a DC mode, a vertical mode, and a horizontal mode, to reference pixels in the first region adjacent to the current block. The step of reordering the one or more candidate modes may also include calculating sum of absolute transformed differences between the prediction pixels and reconstructed pixels in the first region. The step of reordering the one or more candidate modes may include reordering the one or more candidate modes in the MPM list based on the calculated sum of absolute transformed differences. Here, the intra-prediction modes of two neighboring blocks adjacent to the current block may correspond to the intra-prediction modes used to derive the MPM list.

The decoding apparatus may derive the intra-prediction mode of the current block based on one or more candidate modes in the reordered MPM list (S2130). The decoding apparatus may generate a prediction block of the current block based on the intra-prediction mode of the current block (S2140).

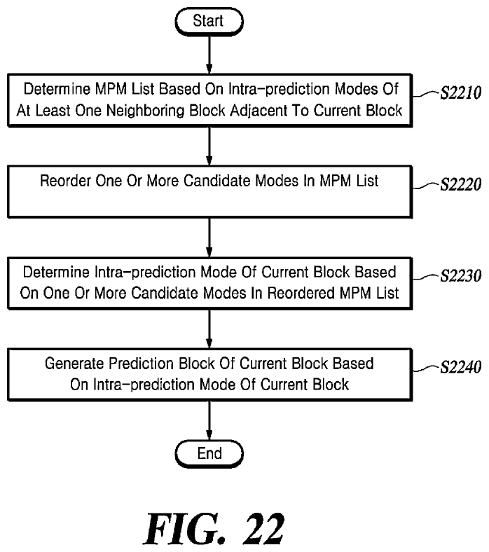

FIG. 22 is a diagram illustrating a video encoding process according to at least one embodiment of the present disclosure.

The encoding apparatus may determine an MPM list based on an intra-prediction mode of at least one neighboring block adjacent to the current block (S2210). The step of determining the MPM list may include generating prediction pixels by applying one or more intra-prediction modes of at least one neighboring block adjacent to the current block, to reference pixels in the first region adjacent to the current block. The step of determining the MPM list may also include calculating sum of absolute transformed differences between the prediction pixels and reconstructed pixels in the first region. The step of determining the MPM list may also include determining the MPM list based on the calculated sum of absolute transformed differences. Here, the MPM list may be determined with priority given to an intra-prediction mode utilized to generate a prediction pixel that causes the least sum among the calculated sum of absolute transformed differences. For the MPM list so determined, the video encoding process may omit to perform the step of reordering the candidate modes in the MPM list with the template-based sum of absolute transformed differences for the candidate modes. The MPM list thus determined may be used to determine an intra-prediction mode of the current block.

The step of determining the MPM list may further include, when the MPM list is not fully populated, determining two intra-prediction modes by using an intra-prediction mode utilized to generate a prediction pixel that causes the least sum among the calculated sum of absolute transformed differences and determining the MPM list based on the two intra-prediction modes.

The encoding apparatus may reorder the one or more candidate modes in the MPM list (S2220). The step of reordering the one or more candidate modes in the MPM list may include generating prediction pixels by applying the one or more candidate modes in the MPM list to reference pixels in the first region adjacent to the current block. The step of reordering the one or more candidate modes may also include calculating sum of absolute transformed differences between the prediction pixels and reconstructed pixels in the first region. The step of reordering the one or more candidate modes may also include reordering the one or more candidate modes in the MPM list based on the calculated sum of absolute transformed differences. Here, the one or more candidate modes in the MPM list may include a planar mode, and the MPM list may be reordered with priority given to a candidate mode utilized to generate a prediction pixel that causes the least sum among the calculated sum of absolute transformed differences.

The step of reordering the one or more candidate modes in the MPM list may include generating, when intra-prediction modes of two neighboring blocks adjacent to the current block are different directional modes, prediction pixels by applying the intra-prediction modes of the two neighboring blocks adjacent to the current block, to reference pixels in the first region adjacent to the current block. The step of reordering the one or more candidate modes may also include calculating sum of absolute transformed differences between the prediction pixels and reconstructed pixels in the first region. The step of reordering the one or more candidate modes may also include reordering the one or more candidate modes in the MPM list based on the calculated sum of absolute transformed differences. Here, the intra-prediction modes of the two neighboring blocks adjacent to the current block may correspond to the intra-prediction modes used to determine the MPM list.

The step of reordering the one or more candidate modes in the MPM list may include generating, when intra-prediction modes of two neighboring blocks adjacent to the current block are different directional modes, prediction pixels by applying the intra-prediction modes of the two neighboring blocks adjacent to the current block and a planar mode, to reference pixels of a first region adjacent to the current block. The step of reordering the one or more candidate modes may also include calculating sum of absolute transformed differences between the prediction pixels and reconstructed pixels in the first region. The step of reordering the one or more candidate modes may also include reordering the one or more candidate modes in the MPM list based on the calculated sum of absolute transformed differences. Here, the intra-prediction modes of the two neighboring blocks adjacent to the current block may correspond to the intra-prediction modes used to determine the MPM list.

The step of reordering the one or more candidate modes in the MPM list may include generating, when intra-prediction modes of two neighboring blocks adjacent to the current block are equal to a directional mode, prediction pixels by applying at least one of two modes, derived from the directional mode, a planar mode, and the directional mode, to reference pixels in the first region adjacent to the current block. The step of reordering the one or more candidate modes may also include calculating sum of absolute transformed differences between the prediction pixels and reconstructed pixels in the first region. The step of reordering the one or more candidate modes may also include reordering the one or more candidate modes in the MPM list based on the calculated sum of absolute transformed differences. Here, the intra-prediction modes of the two neighboring blocks adjacent to the current block may correspond to the intra-prediction modes used to determine the MPM list.

The step of reordering the one or more candidate modes in the MPM list may include generating, when intra-prediction modes of two neighboring blocks adjacent to the current block are non-directional modes, prediction pixels by applying at least one of a planar mode, a DC mode, a vertical mode, and a horizontal mode, to reference pixels in the first region adjacent to the current block. The step of reordering the one or more candidate modes may also include calculating sum of absolute transformed differences between the prediction pixels and reconstructed pixels in the first region. The step of reordering the one or more candidate modes may also include reordering the one or more candidate modes in the MPM list based on the calculated sum of absolute transformed differences. Here, the intra-prediction modes of the two neighboring blocks adjacent to the current block may correspond to the intra-prediction modes used to determine the MPM list.

The encoding apparatus may determine the intra-prediction mode of the current block based on one or more candidate modes in the reordered MPM list (S2230). The encoding apparatus may generate a prediction block of the current block based on the intra-prediction mode of the current block (S2240).

Although the steps in the respective flowcharts are described to be sequentially performed, the steps merely instantiate the technical idea of some embodiments of the present disclosure. Therefore, a person having ordinary skill in the art to which this disclosure pertains could perform the steps by changing the sequences described in the respective drawings or by performing two or more of the steps in parallel. Hence, the steps in the respective flowcharts are not limited to the illustrated chronological sequences.

It should be understood that the above description presents illustrative embodiments that may be implemented in various other manners. The functions described in some embodiments may be realized by hardware, software, firmware, and/or their combination. It should also be understood that the functional components described in this specification are labeled by “. . . unit” to strongly emphasize the possibility of their independent realization.

Meanwhile, various methods or functions described in some embodiments may be implemented as instructions stored in a non-transitory recording medium that can be read and executed by one or more processors. The non-transitory recording medium may include, for example, various types of recording devices in which data is stored in a form readable by a computer system. For example, the non-transitory recording medium may include storage media such as erasable programmable read-only memory (EPROM), flash drive, optical drive, magnetic hard drive, and solid state drive (SSD) among others.

Although embodiments of the present disclosure have been described for illustrative purposes, those having ordinary skill in the art to which this disclosure pertains should appreciate that various modifications, additions, and substitutions are possible, without departing from the idea and scope of the present disclosure. Therefore, embodiments of the present disclosure have been described for the sake of brevity and clarity. The scope of the technical idea of the embodiments of the present disclosure is not limited by the illustrations. Accordingly, those having ordinary skill in the art to which this disclosure pertains should understand that the scope of the present disclosure is not to be limited by the above explicitly described embodiments but by the claims and equivalents thereof.

### Reference Number

122: intra predictor
510: entropy decoder
542: intra predictor

What is claimed is:

1. A video decoding method, comprising:
deriving a Most Probable Mode (MPM) list based on intra-prediction modes of at least one neighboring block adjacent to a current block;
reordering one or more candidate modes in the MPM list;
deriving an intra-prediction mode of the current block based on one or more candidate modes in a reordered MPM list; and
generating a prediction block of the current block based on the intra-prediction mode of the current block.

2. The video decoding method of claim 1, wherein reordering the one or more candidate modes in the MPM list comprises:
generating prediction pixels by applying the one or more candidate modes in the MPM list to reference pixels of a first region adjacent to the current block;
calculating sum of absolute transformed differences between the prediction pixels and reconstructed pixels in the first region; and
reordering the one or more candidate modes in the MPM list based on the sum of absolute transformed differences,
wherein the one or more candidate modes in the MPM list comprise a planar mode, and
wherein the MPM list is reordered with priority given to a candidate mode utilized to generate a prediction pixel that causes a least calculated sum of absolute transformed differences.

3. The video decoding method of claim 2, wherein the first region comprises at least one of a top region, a left region, and a top-left region of the current block.

4. The video decoding method of claim 1, wherein reordering the one or more candidate modes in the MPM list comprises:
when intra-prediction modes of two neighboring blocks adjacent to the current block are different directional modes, generating prediction pixels by applying the intra-prediction modes of the two neighboring blocks adjacent to the current block, to reference pixels of a first region adjacent to the current block;
calculating sum of absolute transformed differences between the prediction pixels and reconstructed pixels in the first region; and
reordering the one or more candidate modes in the MPM list based on the sum of absolute transformed differences,
wherein the intra-prediction modes of the two neighboring blocks adjacent to the current block are the intra-prediction modes that are used to derive the MPM list.

5. The video decoding method of claim 1, wherein reordering the one or more candidate modes in the MPM list comprises:
when intra-prediction modes of two neighboring blocks adjacent to the current block are different directional modes, generating prediction pixels by applying the intra-prediction modes of the two neighboring blocks adjacent to the current block and a planar mode, to reference pixels of a first region adjacent to the current block;
calculating sum of absolute transformed differences between the prediction pixels and reconstructed pixels in the first region; and
reordering the one or more candidate modes in the MPM list based on the sum of absolute transformed differences,
wherein the intra-prediction modes of the two neighboring blocks adjacent to the current block are the intra-prediction modes that are used to derive the MPM list.

6. The video decoding method of claim 1, wherein reordering the one or more candidate modes in the MPM list comprises:
when intra-prediction modes of two neighboring blocks adjacent to the current block are equal to a directional mode, generating prediction pixels by applying at least one of two modes, derived from the directional mode, a planar mode, and the directional mode, to reference pixels of a first region adjacent to the current block;
calculating sum of absolute transformed differences between the prediction pixels and reconstructed pixels in the first region; and
reordering the one or more candidate modes in the MPM list based on the sum of absolute transformed differences,
wherein the intra-prediction modes of the two neighboring blocks adjacent to the current block are the intra-prediction modes that are used to derive the MPM list.

7. The video decoding method of claim 1, wherein reordering the one or more candidate modes in the MPM list comprises:
when intra-prediction modes of two neighboring blocks adjacent to the current block are a directional mode and a non-directional mode, respectively, generating prediction pixels by applying at least one of two modes, derived from the directional mode, a planar mode, and the directional mode, to reference pixels of a first region adjacent to the current block;
calculating sum of absolute transformed differences between the prediction pixels and reconstructed pixels in the first region; and
reordering the one or more candidate modes in the MPM list based on the sum of absolute transformed differences,
wherein the intra-prediction modes of the two neighboring blocks adjacent to the current block are the intra-prediction modes that are used to derive the MPM list.

8. The video decoding method of claim 1, wherein reordering the one or more candidate modes in the MPM list comprises:
when intra-prediction modes of two neighboring blocks adjacent to the current block are non-directional modes, generating prediction pixels by applying at least one of a planar mode, a DC mode, a vertical mode, and a horizontal mode, to reference pixels of a first region adjacent to the current block;
calculating sum of absolute transformed differences between the prediction pixels and reconstructed pixels in the first region; and
reordering the one or more candidate modes in the MPM list based on the sum of absolute transformed differences,
wherein the intra-prediction modes of the two neighboring blocks adjacent to the current block are the intra-prediction modes that are used to derive the MPM list.

9. The video decoding method of claim 1, wherein deriving the MPM list comprises:
generating prediction pixels by applying intra-prediction modes of at least one neighboring block adjacent to the current block, to reference pixels of a first region adjacent to the current block;
calculating sum of absolute transformed differences between the prediction pixels and reconstructed pixels in the first region; and
deriving the MPM list based on the sum of absolute transformed differences,
wherein the MPM list is derived with priority given to an intra-prediction mode utilized to generate a prediction pixel that causes a least calculated sum of absolute transformed differences,
wherein the video decoding method omits the reordering the one or more candidate modes in the MPM list, and
wherein deriving the intra-prediction mode of the current block includes deriving the intra-prediction mode of the current block based on a derived MPM list.

10. The video decoding method of claim 9, wherein deriving the MPM list further comprises:
when the MPM list is not fully populated, deriving two intra-prediction modes by using an intra-prediction mode utilized to generate a prediction pixel that causes the least calculated sum of absolute transformed differences; and
deriving the MPM list based on the two intra-prediction modes.

11. A video encoding method, comprising:
determining a Most Probable Mode (MPM) list of based on intra-prediction modes of at least one neighboring block adjacent to a current block;
reordering one or more candidate modes in the MPM list;
determining an intra-prediction mode of the current block based on one or more candidate modes in a reordered MPM list; and
generating a prediction block of the current block based on the intra-prediction mode of the current block.

12. The video encoding method of claim 11, wherein reordering the one or more candidate modes in the MPM list comprises:
generating prediction pixels by applying the one or more candidate modes in the MPM list to reference pixels of a first region adjacent to the current block;
calculating sum of absolute transformed differences between the prediction pixels and reconstructed pixels in the first region; and
reordering the one or more candidate modes in the MPM list based on the sum of absolute transformed differences,
wherein the one or more candidate modes in the MPM list include a planar mode, and
wherein the MPM list is reordered with priority given to a candidate mode utilized to generate a prediction pixel that causes a least calculated sum of absolute transformed differences.

13. The video encoding method of claim 11, wherein reordering the one or more candidate modes in the MPM list comprises:
when intra-prediction modes of two neighboring blocks adjacent to the current block are different directional modes, generating prediction pixels by applying the intra-prediction modes of the two neighboring blocks adjacent to the current block, to reference pixels of a first region adjacent to the current block;
calculating sum of absolute transformed differences between the prediction pixels and reconstructed pixels in the first region; and
reordering the one or more candidate modes in the MPM list based on the sum of absolute transformed differences,
wherein the intra-prediction modes of the two neighboring blocks adjacent to the current block are the intra-prediction modes that are used to determine the MPM list.

14. The video encoding method of claim 11, wherein reordering the one or more candidate modes in the MPM list comprises:
when intra-prediction modes of two neighboring blocks adjacent to the current block are different directional modes, generating prediction pixels by applying the intra-prediction modes of the two neighboring blocks adjacent to the current block and a planar mode, to reference pixels of a first region adjacent to the current block;
calculating sum of absolute transformed differences between the prediction pixels and reconstructed pixels in the first region; and
reordering the one or more candidate modes in the MPM list based on the sum of absolute transformed differences,
wherein the intra-prediction modes of the two neighboring blocks adjacent to the current block are the intra-prediction modes that are used to determine the MPM list.

15. The video encoding method of claim 11, wherein reordering the one or more candidate modes in the MPM list comprises:
when intra-prediction modes of two neighboring blocks adjacent to the current block are equal to a directional mode, generating prediction pixels by applying at least one of two modes, derived from the directional mode, a planar mode, and the directional mode, to reference pixels of a first region adjacent to the current block;
calculating sum of absolute transformed differences between the prediction pixels and reconstructed pixels in the first region; and
reordering the one or more candidate modes in the MPM list based on the sum of absolute transformed differences,
wherein the intra-prediction modes of the two neighboring blocks adjacent to the current block are the intra-prediction modes that are used to determine the MPM list.

16. The video encoding method of claim 11, wherein reordering the one or more candidate modes in the MPM list comprises:
when intra-prediction modes of two neighboring blocks adjacent to the current block are a directional mode and a non-directional mode, respectively, generating prediction pixels by applying at least one of two modes, derived from the directional mode, a planar mode, and the directional mode, to reference pixels of a first region adjacent to the current block;
calculating sum of absolute transformed differences between the prediction pixels and reconstructed pixels in the first region; and
reordering the one or more candidate modes in the MPM list based on the sum of absolute transformed differences,
wherein the intra-prediction modes of the two neighboring blocks adjacent to the current block are the intra-prediction modes that are used to determine the MPM list.

17. The video encoding method of claim 11, wherein reordering the one or more candidate modes in the MPM list comprises:
when intra-prediction modes of two neighboring blocks adjacent to the current block are non-directional modes, generating prediction pixels by applying at least one of a planar mode, a DC mode, a vertical mode, and a horizontal mode, to reference pixels of a first region adjacent to the current block;
calculating sum of absolute transformed differences between the prediction pixels and reconstructed pixels in the first region; and
reordering the one or more candidate modes in the MPM list based on the sum of absolute transformed differences,
wherein the intra-prediction modes of the two neighboring blocks adjacent to the current block are the intra-prediction modes that are used to determine the MPM list.

18. The video encoding method of claim 11, wherein determining the MPM list comprises:
generating prediction pixels by applying one or more intra-prediction modes of at least one neighboring block adjacent to the current block, to reference pixels of a first region adjacent to the current block;
calculating sum of absolute transformed differences between the prediction pixels and reconstructed pixels in the first region; and
determining the MPM list based on the sum of absolute transformed differences,
wherein the MPM list is determined with priority given to an intra-prediction mode utilized to generate a prediction pixel that causes a least calculated sum of absolute transformed differences,
wherein the video encoding method omits the reordering the one or more candidate modes in the MPM list, and
wherein determining the intra-prediction mode of the current block includes determining the intra-prediction mode of the current block based on a determined MPM list.

19. The video encoding method of claim 18, wherein the determining of the MPM list further comprises:
when the MPM list is not fully populated, determining two intra-prediction modes by using an intra-prediction mode utilized to generate a prediction pixel that causes the least calculated sum of absolute transformed differences; and
determining the MPM list based on the two intra-prediction modes.

20. A computer-readable recording medium storing a bitstream generated by a video encoding method that comprises:
determining a Most Probable Mode (MPM) list based on intra-prediction modes of at least one neighboring block adjacent to a current block;
reordering one or more candidate modes in the MPM list;
determining an intra-prediction mode of the current block based on one or more candidate modes in a reordered MPM list; and
generating a prediction block of the current block based on the intra-prediction mode of the current block.
